(19) United States
(12) Patent Application Publication
(10) Pub. No.: US 2026/0355691 A1
(43) Pub. Date: Nov. 12, 2026

(54) CENTRIFUGE-FREE SEPARATION OF SOLUTION-EXFOLIATED TWO-DIMENSIONAL NANOSHEETS VIA CROSS-FLOW FILTRATION, AND APPLICATIONS OF THE SAME

(71) Applicant: NORTHWESTERN UNIVERSITY, Evanston, IL (US)

(72) Inventors: Mark C. Hersam, Wilmette, IL (US); Julia R. Downing, Chicago, IL (US); Lindsay E. Chaney, Evanston, IL (US); Santiago Diaz-Arauzo, Chicago, IL (US); Jung-Woo T. Seo, Troy, MI (US)

(21) Appl. No.: 19/132,897

(22) PCT Filed: Nov. 27, 2023
(86) PCT No.: PCT/US2023/081066

§ 371 Date: May 27, 2025

Related U.S. Application Data
(60) Provisional application No. 63/385,454, filed on Nov. 30, 2022.

(51) Int. Cl. B01D 61/18; B01D 61/14; B01D 69/02; B01D 71/68; C01B 32/19; C01B 32/196; C09D 11/322; C09D 11/52

(52) U.S. Cl. CPC B01D 61/18; B01D 61/145; B01D 61/147; B01D 69/02; B01D 71/68; C01B 32/19; C01B 32/196; C09D 11/322; C09D 11/52; B01D 2313/243; B01D 2313/60; B01D 2313/70; B01D 2315/10; B01D 2325/02834; B01D 2325/20; C01B 2204/22; C01P 2002/82; C01P 2002/88; C01P 2004/03; C01P 2006/40

(57) ABSTRACT

One aspect of this invention relates to an apparatus and a method for two-dimensional (2D) material separation and material recovery. The method includes providing a mixture dispersion containing 2D material, at least one processing solvent and at least one stabilizing polymer; cross-flow filtering the mixture dispersion into a permeate dispersion; and cross-flow filtering the permeate dispersion into a fine retentate dispersion and a fine permeate dispersion, wherein the fine retentate dispersion comprises the 2D material and the fine permeate dispersion comprises the at least one processing solvent and the at least one stabilizing polymer.

### CROSS-REFERENCE TO RELATED PATENT APPLICATION

This application claims priority to and the benefit of U.S. Provisional Application Ser. No. 63/385,454, filed Nov. 30, 2022, which is incorporated herein in its entirety by reference.

### STATEMENT AS TO RIGHTS UNDER FEDERALLY-SPONSORED RESEARCH

This invention was made with government support under CMMI-2037026 and DMR-1720139 awarded by the National Science Foundation. The government has certain rights in the invention.

### FIELD OF THE INVENTION

The present invention generally relates to material science, particularly to centrifuge-free separation of solution-exfoliated two-dimensional nanosheets via cross-flow filtration, and applications of the same.

### BACKGROUND OF THE INVENTION

The background description provided herein is to present the context of the invention generally. The subject matter discussed in the background of the invention section should not be assumed to be prior art merely due to its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

The superlative properties of two-dimensional (2D) materials (e.g., graphene, hexagonal boron nitride (hBN), and molybdenum disulfide (MoS₂)) have led to increasing interest in their production and integration into diverse structural, electronic, and energy technologies. While electronic-grade 2D materials can be realized through epitaxial growth, this bottom-up manufacturing approach has limited scalability and thus is not viable for high-volume applications. Consequently, significant effort has been devoted to liquid-phase exfoliation (LPE) as a nominally more scalable, top-down approach wherein cavitation-induced shearing exfoliates 2D nanosheets from layered van der Waals solids during ultrasonication. To further improve the throughput of LPE, shear mixing and wet jet milling have emerged as alternatives to ultrasonication. However, since LPE invariably yields incomplete exfoliation, additional lower-throughput separation steps are needed to achieve sufficient 2D nanosheet size monodispersity for high-performance applications.

As the first van der Waals layered material to be exfoliated, graphene is often viewed as the prototypical 2D material and has been explored most extensively for industrial applications including structural composites, batteries, sensors, and printed electronics. Printable conductive inks are among the most promising applications for graphene, but also impose the most stringent manufacturing requirements since chemical modifications to the graphene basal plane compromise electronic properties. In addition, the electrical conductivity of printed graphene thin films depends sensitively on the morphology of the percolating network, which implies that the constituent graphene nanosheets need to be highly monodisperse in nanoscale size.

Therefore, following LPE, graphene dispersions are subjected to centrifuge-based separation (CBS) to improve graphene nanosheet size monodispersity. While CBS processes such as density gradient ultracentrifugation (DGU) and liquid cascade centrifugation (LCC) produce highly monodisperse graphene dispersions, these methods are energy-intensive and intrinsically limited in their scalability.

To address CBS limitations, alternative solution-based separation methods have been developed, but have been primarily applied in the biochemistry and pharmaceutical fields, leaving their utility for 2D material separations relatively unexplored. Examples include chromatography, field-flow fractionation, force-field extraction, magnetic separation, microfiltration, and ultrafiltration. However, no technology for post-exfoliation processing of graphene has been demonstrated commercially that can mitigate the large capital equipment costs and significant energy burden associated with CBS.

Therefore, a heretofore unaddressed need exists in the art to address the aforementioned deficiencies and inadequacies.

### SUMMARY OF THE INVENTION

One of the objectives of this invention is to address this need by demonstrating a continuous-flow, high-throughput, and energy-efficient post-exfoliation graphene separation process based on cross-flow filtration (CFF). Furthermore, by changing the membrane pore size from the microfiltration to the ultrafiltration regime, CFF not only addresses the centrifugal separation bottleneck for LPE graphene but also facilitates recovery and recycling of excess solvents and stabilizing polymers. The novel CFF process features a polydisperse, shear-exfoliated mixture flowing tangentially to the surface of a porous membrane, minimizing material buildup on the membrane surface and avoiding entrapment of larger particles in the membrane interior. Meanwhile, graphene nanosheets traverse the membrane pores via cross-flow for collection in a monodisperse, nanoscale permeate dispersion. These permeate graphene nanosheets show comparable size characteristics and electrical conductivity to centrifuged samples, but with orders of magnitude improvement in manufacturing throughput. When coupled with inline recovery and recycling of excess solvents and stabilizing polymers, CFF processing also provides substantial improvements in other sustainability metrics such as reductions in greenhouse gas emissions, fossil energy usage, and water consumption.

In one aspect, the invention relates to an apparatus for 2D material separation and material recovery. The apparatus comprises a first cross-flow filtration system, and a second cross-flow filtration system. Each of the first and second cross-flow filtration systems comprises a feed reservoir receiving a feed dispersion; a feed pump fluidically coupled to the feed reservoir for delivering the feed dispersion; a permeate pump; and a cross-flow filter cartridge of varying configurations having feed, retentate, and permeate ports fluidically and respectively coupled to the feed pump, the feed reservoir and the permeate pump for cross-flow filtration of the feed dispersion into a retentate dispersion that is returned into the feed reservoir and a permeate dispersion that is collected through the permeate pump. The feed reservoir of the first cross-flow filtration system is operably fed with a mixture dispersion containing a 2D material, at least one processing solvent and at least one stabilizing polymer; and the permeate dispersion of the first cross-flow filtration system is fed to the feed reservoir of the second cross-flow filtration system. The retentate dispersion of the second cross-flow filtration system contains a concentrated dispersion of the 2D material, and the permeate dispersion of the second cross-flow filtration system is collected for recovery of the at least one processing solvent and the at least one stabilizing polymer.

In one embodiment, the apparatus further comprises a flow controller for controlling operations of the feed pumps of the first and second cross-flow filtration systems.

In one embodiment, the controller comprises a first controller and a second controller respectively coupled to the first and second cross-flow filtration systems for the operations of the feed pumps of the first and second cross-flow filtration systems.

In one embodiment, each of the first and second cross-flow filtration systems further comprises a plurality of pressure sensors for monitoring pressure at the feed, retentate, and permeate ports, respectively.

In one embodiment, the cross-flow filter comprises cross-flow filtration (CFF) membranes in tubular, flat sheet, spiral-wound, and/or hollow-fiber configurations.

In one embodiment, the CFF filter membrane is composed of a polymeric material including polysulfone (PS), polyethersulfone (PES), modified polyethersulfone (mPES), mixed cellulose ester (MCE), nylon, polyacrylonitrile (PAN), polypropylene (PP), and/or polyimide (PI).

In one embodiment, the CFF filter membrane surface is composed of a ceramic material including silicon carbide (SiC), titania (TiO₂), zirconia (ZrO₂), yttrium-stabilized zirconia (YSZ), or alumina (Al₂O₃).

In one embodiment, the CFF membranes are charged membranes.

In one embodiment, the first cross-flow filtration system is a cross-flow microfiltration (CF-MF) system with the CFF membranes having microscale pores with pore sizes in a range of about 0.1-1 μm.

In one embodiment, the pore sizes have a mean pore size of approximately 0.65 μm.

In one embodiment, the second cross-flow filtration system is a cross-flow ultrafiltration (CF-UF) system with the CFF membranes having nanoscale pores with nanoscale sizes.

In one embodiment, the nanoscale pore sizes are in a range of 500-750 kDa NMWC.

In one embodiment, the 2D material comprises a liquid-exfoliated 2D material from van der Waals layered solids.

In one embodiment, the liquid-exfoliated 2D material comprises graphene, black phosphorous (BP), hexagonal boron nitride (hBN), molybdenum disulfide (MoS₂), tungsten disulfide (WS₂), germanium sulfide (GeS), tin disulfide (SnS₂), tantalum disulfide (TaS₂), rhenium disulfide (ReS₂), molybdenum diselenide (MoSe₂), tin selenide (SnSe), tungsten diselenide (WSe₂), bismuth selenide (Bi₂Se₃), indium selenide (InSe), molybdenum ditelluride (MoTe₂), gallium telluride (GaTe), or any of other liquid-phase exfoliated materials derived from layered oxides, layered hydroxides, and layered silicates.

In one embodiment, the at least one processing solvent comprises ethanol, and the at least one stabilizing polymer comprises ethyl cellulose (EC), carboxymethylcellulose (CMC), hydroxypropyl methylcellulose (HPMC), nanocrystalline cellulose (CNC); other naturally occurring biopolymers including chitosan, collagen, or starch; a synthesized macromolecule including polyvinylpyrrolidine (PVP), polyethylene oxide (PEO), or block copolymers such as poloxamers, small aromatic molecules, including pyrene derivatives; or small-molecule surfactants including sodium cholate (SC), sodium dodecyl sulfate (SDS), or sodium deoxycholate (SDC).

In one embodiment, the CF-MF permeate is fed in the feed port of the CF-UF as the feed dispersion for the CF-UF, with ethanol and EC then traversing the CF-UF membrane into the CF-UF permeate.

In one embodiment, the CF-UF retentate of the CF-UF comprises electronic-grade 2D nanoparticles usable for formulating a printable ink.

In another aspect, the invention relates to a method for 2D material separation and material recovery. The method comprises providing a mixture dispersion containing 2D material, at least one processing solvent and at least one stabilizing polymer; cross-flow filtering the mixture dispersion into a permeate dispersion; and cross-flow filtering the permeate dispersion into a fine retentate dispersion and a fine permeate dispersion, wherein the fine retentate dispersion comprises the 2D material and the fine permeate dispersion comprises the at least one processing solvent and the at least one stabilizing polymer.

In one embodiment, each of said cross-flow filtering the mixture dispersion and said cross-flow filtering the permeate dispersion is performed with a cross-flow filtration system having a cross-flow filter comprising CFF membranes in tubular, flat sheet, spiral-wound, and/or hollow-fiber configurations.

In one embodiment, said cross-flow filtering the mixture dispersion is performed with a CF-MF system with the CFF membranes having microscale pores with pore sizes in a range of about 0.1-1 μm. In one embodiment, the pore sizes are about 0.65 μm.

In one embodiment, said cross-flow filtering the permeate dispersion is performed with a CF-UF system with the CFF membranes having nanoscale pores with nanoscale sizes. In one embodiment, the nanoscale pore sizes are in a range of 500-750 kDa NMWC.

In one embodiment, each of said cross-flow filtering the mixture dispersion and said cross-flow filtering the permeate dispersion comprises slowly increasing a feed flow rate to about 50-100% of the maximum afforded by a feed pump; and gradually increasing a permeate flow rate towards a predetermined target parameter based on the membrane surface area until the transmembrane pressure (TMP) is maximized and stable.

In one embodiment, said cross-flow filtering the permeate dispersion is conducted in concentration mode to facilitate ethanol recovery.

In one embodiment, the permeate flow rate of said cross-flow filtering the permeate dispersion is higher than that of said cross-flow filtering the mixture dispersion.

In one embodiment, the mixture dispersion is provided by liquid-phase exfoliation (LPE) of van der Waals layered solids in the presence of the at least one stabilizing polymer.

In one embodiment, the 2D material comprises a liquid-exfoliated 2D material from van der Waals layered solids.

In one embodiment, the liquid-exfoliated 2D material comprises graphene, BP, hBN, MoS₂, WS₂, GeS, SnS₂, TaS₂, ReS₂, MoSe₂, SnSe, WSe₂, Bi₂Se₃, InSe, MoTe₂, GaTe, or any of other liquid-phase exfoliated materials derived from layered oxides, layered hydroxides, and layered silicates.

In one embodiment, the at least one processing solvent comprises ethanol, and the at least one stabilizing polymer comprises EC, CMC, HPMC, CNC; other naturally occurring biopolymers, such as chitosan, collagen, or starch; a synthesized macromolecule, such as PVP, PEO, or block copolymers such as poloxamers; small aromatic molecules, such as pyrene derivatives; or small-molecule surfactants, such as SC, SDS, SDC.

In one embodiment, the method reduces greenhouse gas emissions, fossil energy usage, water consumption, and specific production costs of 2D material manufacturing by about 57%, 56%, 63%, and 52%, respectively, compared to conventional centrifuge-based separation (CBS) processing.

In one embodiment, the fine retentate dispersion comprises electronic-grade 2D nanoparticles usable for formulating a printable ink.

In yet another aspect, the invention relates to a printable ink comprising the 2D material separated by the above disclosed method.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows a schematic overview of the continuous-flow pathway to processing graphene nanosheets with cross-flow filtration (CFF) according to embodiments of the invention. Panel a: Graphite is exfoliated via continuous-flow shear mixing in the presence of ethanol and ethyl cellulose. Panel b: Shear-mixed dispersions are processed via the CFF using a hollow fiber microfiltration cartridge (CF-MF). Panel c: Graphene nanosheets traverse the porous wall of the lumen and are pumped out through the permeate port, while poorly exfoliated graphite particles remain in the retentate. Panel d: By increasing the feed flow rate and filtration surface area, CFF can be scaled to 10 L volumes and beyond. Panel e: Ethanol and ethyl cellulose recovery is achieved by a second stage of the CFF that utilizes the nanoscale pore size of hollow fiber ultrafiltration cartridges (CF-UF). Panel f: The final graphene/EC powders are formulated into printable inks that yield highly conductive films.

FIG. 2 shows how a polarization layer formation at the membrane surface controls filtration according to embodiments of the invention. Panel a: During stable operation, shear-mixed dispersions flow through the hollow fiber membrane in a parabolic flow profile. Graphene nanosheets traverse the membrane and exit via the permeate port, while poorly exfoliated graphitic particles flow through the channel and exit via the retentate port. With time, poorly exfoliated graphitic particles also build up on the fiber walls, leading to a compact polarization layer. Panel b: At high channel flow rates and low feed stream concentrations, the polarization layer remains sufficiently porous to enable graphene nanosheets to be continuously collected at the permeate port. Panel c: At low channel flow rates and high feed stream concentrations, a compact polarization layer forms that leads to membrane fouling. Panels d-f: Post-mortem scanning electron microscopy shows: (panel d) highly porous microstructure of the polysulfone fiber lumen wall, (panel e) zoomed-out view of the lumen cross-section, and (panel f) graphite polarization layer that forms on the lumen interior surface after extended operation.

FIG. 3 shows efficacy of cross-flow microfiltration for size separation of polydisperse graphene nanosheets according to embodiments of the invention. Panels a-b: Representative scanning electron microscopy (SEM) images highlighting differences in the particle size characteristics of (panel a) feed and retentate dispersions, which are virtually indistinguishable via SEM, and (panel b) CF-MF permeate dispersion that exclusively contains graphene nanosheets. Panel c: Particle size analysis via dynamic light scattering (DLS) shows that the retentate and permeate peaks are larger and smaller than the feed peak, respectively. Three independent measurements are shown in each case, illustrating more consistent results for the permeate compared to the retentate or feed. Panel d: Comparison of correlograms from DLS show a smoother correlation function for CF-MF permeate dispersions. Panel e: Cumulative particle size (Z-Average) and polydispersity index (PDI) for the permeate, feed, and retentate. Panel f: Comparison of the mass throughput of CFF compared to other separation schemes for solution-processed 2D nanomaterials.

FIG. 4 shows that CFF-processed graphene yields printable inks with high electrical conductivity, according to embodiments of the invention. Panels a-b: CFF-processed GrEC is formulated into inks that are compatible with (panel a) aerosol-jet printing (CFF-AJP) and (panel b) inkjet printing (CFF-IJP). Panel c: Viscosity as a function of shear rate for the two printable graphene inks. The viscosity can be further tuned by adjusting the solids loading of graphene in the ink formulation. Panel d: After printing and thermal decomposition of EC, the resulting graphene films show an Ohmic response with electrical conductivities exceeding 10⁴ S/m.

FIG. 5 shows that cross-flow filtration improves environmental and cost impacts of graphene manufacturing, according to embodiments of the invention. Panel a: Schematic overview of the pilot-scale CFF apparatus that uses a high-flow peristaltic pump with maximum shear rates of ~16,000 s⁻¹. Panel b: Life cycle assessment (LCA) and Panel c: techno-economic analysis (TEA) results for CFF in comparison to centrifuge-based sedimentation (CBS). The dashed lines in panel c indicate a breakdown of the specific production cost without including the cost of raw materials.

FIG. 6 shows TMP trends in diafiltration mode indicate ideal filtration conditions for graphene separation according to embodiments of the invention. Panel a: Graphene concentration in CFF permeate dispersion (C_{Permeate}) versus time as determined by the Lambert-Beer law for the as-dispersed sample (without dilution). Attempts to reuse 0.65 μm CF-MF filter cartridges resulted in rapidly declining yield with successive filtration trials. Panel b: Pressure sensor data from the AKTA flux indicates that the TMP peaks around 8 PSI initially, but subsequently destabilizes within <1 hr for concentrated feed dispersions (C_{Feed} ~10⁰ mg/mL). Panel c: Meanwhile, a lower C_{Feed} showed steady graphene extraction until total depletion in diafiltration mode (Cₚₑᵣₘₑₐₜₑ 0 mg/mL). Panel d: In this scenario, the TMP decay remains lower for C_{Feed} ~10⁻¹ mg/mL. CFF proceeded for up to 4 hr with TMP<1.0 PSI until the sample was depleted of graphene. Panel e: A similar trend in TMP as a function of time was maintained for pilot-scale CFF experiments using the same C_{Feed} ~0.3 mg/mL.

FIG. 7 shows SEM images of membrane lumen interior illustrating the effect of feed concentration, C_{Feed}, on fouling during CF-MF according to embodiments of the invention. Panel a: The combination of low feed concentration (C_{Feed} ~10⁻¹ mg/mL) and high cross-flow rate (q 0.343 L/min) preserves the unobstructed PS matrix at the membrane surface. Panel b: At higher feed concentrations (C_{Feed} ~10⁰ mg/mL), the topology of the membrane surface is still visible, but large graphite flakes partially obscure the pores and lead to a decrease in flux. Panel c: At the highest attempted feed concentrations (C_{Feed} ~10¹ mg/mL), large graphite flakes completely obscure the membrane surface, and entrapment of graphite in the membrane microstructure leads to lumen rupture and loss of functionality.

FIG. 8 shows rheological characterization of as-received and recovered EC according to embodiments of the invention. Successive measurements of (panels a-b) complex viscosity and (panels c-d) shear stress of EC samples. As-received material from Millipore Sigma exhibited similar characteristics as EC recovered from CF-UF experiments. All samples were redispersed in an 80:20 mixture of toluene:ethanol.

FIG. 9 shows thermogravimetric analysis of CF-UF retentate and permeate dispersions according to embodiments of the invention. Panel a: Flocculated GrEC solids show an increase in relative graphene levels following CF-UF. Panel b: Mass evolution curves of recovered EC compared to as-purchased EC.

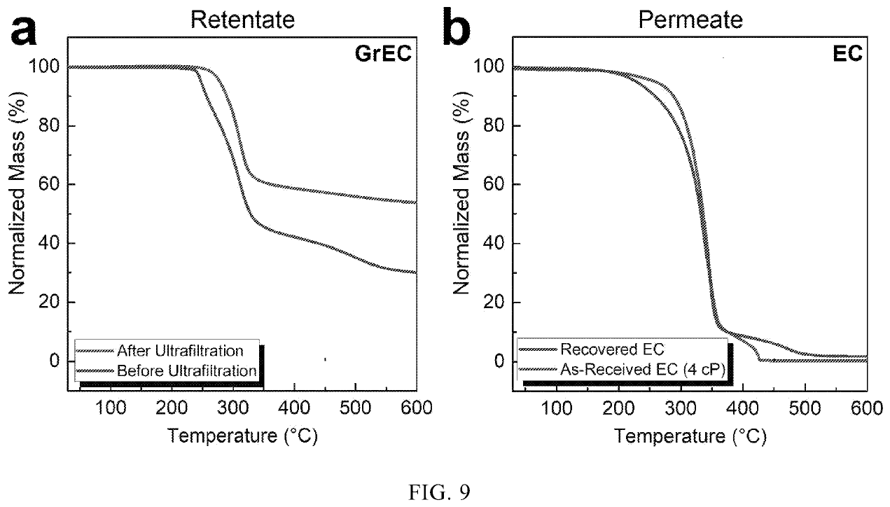

FIG. 10 shows physicochemical characteristics of CFF-derived GrEC powder according to embodiments of the invention. Panel a: SEM of CFF-derived powder after flocculation, rinsing, and drying shows angular graphene nanosheets interspersed with amorphous EC. Panel b: Thermogravimetric analysis of the GrEC powder in compressed air indicates a graphene to EC weight ratio of 1:4. Panel c: Raman spectroscopy of graphene films following redispersion, spin-coating, and thermal treatment of GrEC shows characteristic peaks of graphene and an I_{D}/I_{G} ratio of 0.358. Panel d: X-ray photoelectron spectroscopy (XPS) for spin-coated graphene films before and after thermal decomposition of the EC polymer with the latter showing enhancement of the anisotropic sp² C-C peak characteristic of graphene.

FIG. 11 shows detailed Raman spectroscopy analysis of spin-coated graphene films illustrating suitability for electronic applications.

### DETAILED DESCRIPTION OF THE INVENTION

The invention will now be described more fully hereinafter with reference to the accompanying drawings, in which exemplary embodiments of the invention are shown.

However, this invention may be embodied in many different forms and should not be construed as limited to the embodiments set forth herein. Rather, these embodiments are provided so that this specification will be thorough and complete and fully convey the invention's scope to those skilled in the art. Like reference numerals refer to like elements throughout.

The terms used in this specification generally have their ordinary meanings in the art, within the context of the invention, and in the specific context where each term is used. Certain terms used to describe the invention are discussed below, or elsewhere in the specification, to provide additional guidance to the practitioner regarding the description. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein.

Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, or section without departing from the invention's teachings.

Furthermore, relative terms, such as “lower” or “bottom” and “upper” or “top,” may be used herein to describe one element's relationship to another element as illustrated in the figures.

It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. Therefore, the exemplary terms “below” or “beneath” can encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

Significant effort in the field of nanomaterials has been devoted to liquid-phase exfoliation (LPE), wherein cavitation-induced shearing exfoliates 2D nanosheets from layered van der Waals materials. However, since the LPE is a low-yield process, additional lower-throughput separation steps are needed to achieve sufficient 2D nanosheet size monodispersity for high-performance applications. Traditionally, this separation is accomplished by centrifuge-based separation (CBS) to remove poorly exfoliated materials. However, while the CBS processes, such as density gradient ultracentrifugation and liquid cascade centrifugation, produce highly monodisperse graphene, these methods are energy-intensive and intrinsically limited in their scalability.

On the other hand, in cross-flow filtration (CFF), also known as tangential flow filtration (TFF), liquid flows parallel to the membrane surface, thus minimizing fouling. The CFF is ideal for solid/liquid mixtures with a wide range of solids loading and small particle sizes (<5 m).

During the CFF, a feed dispersion of solid particles suspended in liquid is continuously recirculated along a porous membrane surface. The driving force for separation is the transmembrane pressure, which is orthogonal to the primary liquid flow, ultimately pushing sufficiently small particles through the pores. This stream of small particles is known as the permeate, whereas the unfiltered retentate flow remains in closed-loop recirculation to be further filtered with each pass through the CFF. While enrichment of large particles in the retentate is often the targeted outcome of a CFF process, the permeate stream is ideal for isolating small particles from the feed stream, which is the primary objective of 2D material separations.

In the context of nanomaterials, the CFF has been successfully applied to the removal of nanoparticle contaminants from 1D nanowires in addition to achieving separation of 1D carbon nanotubes by length. The CFF has also been used to purify and concentrate graphene quantum dots and related chemically prepared or modified nanomaterials. In all of these cases, the CFF was operated in the standard mode where the retentate was collected for further processing and the permeate was discarded.

In this invention, we reverse the paradigm of the CFF and focus on the permeate as the target stream to isolate monodisperse 2D nanoparticles from larger, incompletely-exfoliated 2D material from van der Waals layered solids. This unconventional application of the CFF is enabled by operation in a regime of high cross-flow and low feed concentration, which efficiently extracts small anisotropic particles with minimal membrane fouling.

In one aspect, the invention relates to an apparatus for 2D material separation and material recovery. The apparatus comprises a first cross-flow filtration system, and a second cross-flow filtration system. Each of the first and second cross-flow filtration systems comprises a feed reservoir receiving a feed dispersion; a feed pump fluidically coupled to the feed reservoir for delivering the feed dispersion; a permeate pump; and a cross-flow filter having feed, retentate, and permeate ports fluidically and respectively coupled to the feed pump, the feed reservoir and the permeate pump for cross-flow filtration of the feed dispersion into a retentate dispersion that is returned into the feed reservoir and a permeate dispersion that is collected through the permeate pump. The feed reservoir of the first cross-flow filtration system is operably fed with a mixture dispersion containing a 2D material, at least one processing solvent and at least one stabilizing polymer; and the permeate dispersion of the first cross-flow filtration system is fed to the feed reservoir of the second cross-flow filtration system. The retentate dispersion of the second cross-flow filtration system contains a concentrated dispersion of the 2D material, and the permeate dispersion of the second cross-flow filtration system is collected for recovery of the at least one processing solvent and the at least one stabilizing polymer.

In one embodiment, the apparatus further comprises a controller for controlling operations of the feed pumps of the first and second cross-flow filtration systems.

In one embodiment, the controller comprises a first controller and a second controller respectively coupled to the first and second cross-flow filtration systems for the operations of the feed pumps of the first and second cross-flow filtration systems.

In one embodiment, each of the first and second cross-flow filtration systems further comprises a plurality of pressure sensors for monitoring pressure at the feed, retentate, and permeate ports, respectively.

In one embodiment, the cross-flow filter comprises cross-flow filtration (CFF) membranes in tubular, flat sheet, spiral-wound, and/or hollow-fiber configurations.

In one embodiment, the CFF filter membrane is composed of a polymeric material including polysulfone (PS), polyethersulfone (PES), modified polyethersulfone (mPES), mixed cellulose ester (MCE), nylon, polyacrylonitrile (PAN), polypropylene (PP), and/or polyimide (PI).

In one embodiment, the CFF filter membrane surface is composed of a ceramic material including silicon carbide (SiC), titania (TiO₂), zirconia (ZrO₂), yttrium-stabilized zirconia (YSZ), or alumina (Al₂O₃).

In one embodiment, the CFF membranes are charged membranes.

In one embodiment, the first cross-flow filtration system is a cross-flow microfiltration (CF-MF) system with the CFF membranes having microscale pores with pore sizes in a range of about 0.1-1 μm.

In one embodiment, the pore sizes have a mean pore size of approximately 0.65 μm.

In one embodiment, the second cross-flow filtration system is a cross-flow ultrafiltration (CF-UF) system with the CFF membranes having nanoscale pores with nanoscale sizes.

In one embodiment, the nanoscale pore sizes are in a range of 500-750 kDa NMWC.

In one embodiment, the 2D material comprises a liquid-exfoliated 2D material from van der Waals layered solids.

In one embodiment, the liquid-exfoliated 2D material comprises graphene, black phosphorous (BP), hexagonal boron nitride (hBN), molybdenum disulfide (MoS₂), tungsten disulfide (WS₂), germanium sulfide (GeS), tin disulfide (SnS₂), tantalum disulfide (TaS₂), rhenium disulfide (ReS₂), molybdenum diselenide (MoSe₂), tin selenide (SnSe), tungsten diselenide (WSe₂), bismuth selenide (Bi₂Se₃), indium selenide (InSe), molybdenum ditelluride (MoTe₂), gallium telluride (GaTe), or any of other liquid-phase exfoliated materials derived from layered oxides, layered hydroxides, and layered silicates.

In one embodiment, the at least one processing solvent comprises ethanol, and the at least one stabilizing polymer comprises ethyl cellulose (EC), carboxymethylcellulose (CMC), hydroxypropyl methylcellulose (HPMC), nanocrystalline cellulose (CNC); other naturally occurring biopolymers including chitosan, collagen, or starch; a synthesized macromolecule including polyvinylpyrrolidine (PVP), polyethylene oxide (PEO), or block copolymers such as poloxamers; small aromatic molecules, including pyrene derivatives; or small-molecule surfactants including sodium cholate (SC), sodium dodecyl sulfate (SDS), or sodium deoxycholate (SDC).

In one embodiment, the CF-MF permeate is fed in the feed port of the CF-UF as the feed dispersion for the CF-UF, with ethanol and EC then traversing the CF-UF membrane into the CF-UF permeate.

In one embodiment, the CF-UF retentate of the CF-UF comprises electronic-grade 2D nanoparticles usable for formulating a printable ink.

In another aspect, the invention relates to a method for 2D material separation and material recovery. The method comprises providing a mixture dispersion containing 2D material, at least one processing solvent and at least one stabilizing polymer; cross-flow filtering the mixture dispersion into a permeate dispersion; and cross-flow filtering the permeate dispersion into a fine retentate dispersion and a fine permeate dispersion, wherein the fine retentate dispersion comprises the 2D material and the fine permeate dispersion comprises the at least one processing solvent and the at least one stabilizing polymer.

In one embodiment, each of said cross-flow filtering the mixture dispersion and said cross-flow filtering the permeate dispersion is performed with a cross-flow filtration system having a cross-flow filter comprising CFF membranes in tubular, flat sheet, spiral-wound, and/or hollow-fiber configurations.

In one embodiment, said cross-flow filtering the mixture dispersion is performed with a CF-MF system with the CFF membranes having microscale pores with pore sizes in a range of about 0.1-1 μm.

In one embodiment, average pore size is approximately 0.65 μm.

In one embodiment, said cross-flow filtering the permeate dispersion is performed with a CF-UF system with the CFF membranes having nanoscale pores with nanoscale sizes. In one embodiment, the nanoscale pore sizes are in a range of 500-750 kDa NMWC.

In one embodiment, each of said cross-flow filtering the mixture dispersion and said cross-flow filtering the permeate dispersion comprises slowly increasing a feed flow rate to about 50-100% of the maximum afforded by a feed pump; and gradually increasing a permeate flow rate towards a predetermined target parameter based on the membrane surface area until the transmembrane pressure (TMP) is maximized and stable.

In one embodiment, said cross-flow filtering the permeate dispersion is conducted in concentration mode to facilitate ethanol recovery.

In one embodiment, the permeate flow rate of said cross-flow filtering the permeate dispersion is higher than that of said cross-flow filtering the mixture dispersion.

In one embodiment, the mixture dispersion is provided by liquid-phase exfoliation (LPE) of van der Waals layered solids in the presence of the at least one stabilizing polymer.

In one embodiment, the 2D material comprises a liquid-exfoliated 2D material from van der Waals layered solids.

In one embodiment, the liquid-exfoliated 2D material comprises graphene, hBN, MoS₂, WS₂, GeS, SnS₂, TaS₂, ReS₂, MoSe₂, SnSe, WSe₂, Bi₂Se₃, InSe, MoTe₂, GaTe, or any of other liquid-phase exfoliated materials derived from layered oxides, layered hydroxides, and layered silicates.

In one embodiment, the at least one processing solvent comprises ethanol, and the at least one stabilizing polymer comprises EC, HPMC, CNC; other naturally occurring biopolymers, such as chitosan, collagen, or starch; a synthesized macromolecule, such as PVP, PEO, or block copolymers such as poloxamers; small aromatic molecules, such as pyrene derivatives; or small-molecule surfactants, such as SC, SDS, SDC.

In one embodiment, the method reduces greenhouse gas emissions, fossil energy usage, water consumption, and specific production costs of 2D material manufacturing by about 57%, 56%, 63%, and 52%, respectively, compared to conventional centrifuge-based separation (CBS) processing.

In one embodiment, the fine retentate dispersion comprises electronic-grade 2D nanoparticles usable for formulating a printable ink.

Yet another aspect of the invention relates to a printable ink comprising the 2D material separated by the above disclosed method.

In one exemplary embodiment, the input graphene dispersion is prepared by LPE of graphite in the presence of EC. The use of EC as a stabilizing polymer minimizes graphene nanosheet reaggregation, enabling high-volume production of concentrated graphene dispersions in ethanol. Moreover, monodisperse graphene/EC (GrEC) dispersions are well-known to produce highly conductive inks, thus providing a direct means for verifying that CFF yields electronic-grade graphene. To demonstrate the scalability of this CFF methodology, successful graphene separation is shown using CF-MF across three volumetric orders of magnitude from the milliliter to the liter scale. The resulting graphene nanosheets exhibit comparable size distributions to CBS control samples, while achieving orders of magnitude improvement in separation throughput.

Following CF-MF isolation of monodisperse graphene nanosheets, CF-UF with nanoscale pores is then employed to recover ethanol and EC, thus facilitating continuous flow recycling and waste minimization. Overall, life cycle assessment (LCA) and techno-economic analysis (TEA) confirm that CFF leads to substantial reductions in greenhouse gas emissions, fossil energy usage, water consumption, and specific production costs of graphene manufacturing.

The invention may find applications in conductive coatings, batteries, flexible electronics, printed electronics, structural composites, supercapacitors, fuel cells, and so on.

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### EXAMPLE

### Centrifuge-Free Separation of Solution-Exfoliated 2D Nanosheets Via Cross-Flow Filtration

Solution-processed graphene is a promising material for numerous high-volume industrial applications including structural composites, batteries, sensors, and printed electronics. However, the polydisperse nature of graphene dispersions following liquid-phase exfoliation poses major manufacturing challenges, as incompletely exfoliated graphite flakes must be removed to achieve optimal properties and downstream performance. Incumbent separation schemes rely on centrifugation, which is highly energy-intensive and limits scalable manufacturing.

In this exemplary study, we introduce cross-flow filtration (CFF) as a centrifuge-free processing method that improves the throughput of graphene separation by two orders of magnitude. By tuning membrane pore sizes between microfiltration and ultrafiltration length scales, CFF can also be used for efficient recovery of solvents and stabilizing polymers. In this manner, life cycle assessment and techno-economic analysis reveal that CFF reduces greenhouse gas emissions, fossil energy usage, water consumption, and specific production costs of graphene manufacturing by 57%, 56%, 63%, and 72%, respectively. To confirm that CFF produces electronic-grade graphene, CFF-processed graphene nanosheets are formulated into printable inks, leading to state-of-the-art thin-film conductivities exceeding 10⁴ S m⁻¹. This CFF methodology can likely be generalized to other van der Waals layered solids, thus enabling sustainable manufacturing of the diverse set of applications currently being pursued for two-dimensional materials.

### Methods

Materials: Graphite flakes (+100 mesh, Catalog No. 332461), ethyl cellulose (4 cP, 5% in 80:20 toluene:ethanol, Catalog No. 200646), cyclohexanone (Catalog No. 398241), and terpineol (Catalog No. 86480) were all purchased from MilliporeSigma (St. Louis, MO). 200-proof ethanol for all experiments was manufactured by Decon Laboratories (King of Prussia, PA) and purchased from Fisher Scientific (Waltham, MA, Catalog No. 04-355-223). Diethylene glycol monomethyl ether (DEGME) was manufactured by TCI Chemicals (Tokyo, JPN) and purchased from Fisher Scientific (Catalog No. M053725ML). For CFF, polysulfone (PS) hollow fiber filtration modules from Cytiva (Marlborough, MA) with pore size cutoffs from 500,000 NMWC (Catalog No. UFP-500-DMA) to 0.65 μm (Catalog No. CFP-6-D-3MA and Catalog No. CFP-6-D-5A) were used.

Liquid-phase exfoliation: Graphite was shear mixed at high speeds using an LM5-A Lab Mixer (Silverson Machines, East Longmeadow, MA). EC was pre-dissolved into ethanol (1% w/v) for each batch using a stir bar at room temperature. The polymer/solvent solution was then combined with the bulk graphite powder (10% w/v graphite) in a 2 L jacketed beaker (Fisher Scientific Catalog No. CG110306). The vessel was cooled with a recirculating chiller (Thermo Fisher, Waltham, MA) to 5 °C, and the mixture of graphite powder and EC/ethanol was shear mixed at 10,230 rpm for 2 hr. The dispersions were allowed to settle overnight before filtration experiments were performed. For CBS control experiments, the resulting dispersion was centrifuged at ~10,500 rcf for 30 minutes using an Avanti-J26 XPI centrifuge equipped with a JLA-8.100 rotor and 1 L polypropylene bottles (Beckman Coulter, Brea, CA) and the supernatant containing graphene nanosheets was extracted.

General cross-flow filtration procedure: At the laboratory scale, filtration experiments were carried out using an AKTA Flux s semi-automated tangential flow filtration/cross-flow filtration system (Cytiva, Product No. 29038437) equipped with three peristaltic pumps—one for the feed dispersion, one for the permeate dispersion, and one to transfer solvent into the reservoir for diafiltration experiments. All pumps were calibrated according to manufacturer instructions.

Brand-new PS hollow fiber modules were mounted, plumbed, and washed with deionized water for 5-120 min prior to use following manufacturer instructions with an AKTA Flux s tubing kit (Cytiva, Product No. 29060952). The hollow fiber filters were subsequently only washed with ethanol for 5 min with a feed pump flow rate of 200 mL min⁻¹ and a permeate dispersion flow rate of 5 mL min⁻¹ between runs. After draining, feed dispersions of LPE graphene in EC/ethanol were poured into the reservoir and stirred. Lab-scale size refinement experiments were performed in diafiltration mode (i.e., maintaining constant reservoir volume with the transfer pump). Each CFF process was carried out with constant feed flow. The pressure and graphene concentration data contained herein are consistent across a minimum of n=3 separate experiments, with or without separate CFF modules.

Cross-flow microfiltration: For the CF-MF, the feed flow rate was first slowly increased to 70-100% of the maximum afforded by the pump (240-343 mL/min). Next, the permeate flow rate was gradually increased towards a predetermined target parameter based on the membrane surface area (Tables 1-2 and 4) until the TMP was maximized and stable. Across all CF-MF experiments, permeate flow rates were modulated from 2.0-6.0 mL/min. The position of the retentate control valve on the instrument was kept constant (i.e., no retentate flow control was used during the process). The CF-MF filter cartridges were flooded and stored in an 80:20 mixture of DI water and ethanol when not in use.

Cross-flow ultrafiltration: For CF-UF, the same procedure as CF-MF was applied with the following differences: (1) experiments were conducted in concentration mode to facilitate ethanol recovery; (2) higher permeate flow rates (e.g., 10 mL min⁻¹) were attained while keeping the TMP in an acceptable range (<10 PSI for CF-UF membranes). After each permeate sample was collected, the filters were thoroughly rinsed with ethanol (feed flow rate=200 mL min⁻¹, permeate flow rate=5 mL min⁻¹) to remove excess material and solvent. Filter modules were rated with 500-750 kDa NMWC pore size, and CF-MF permeate was used as the feed dispersion for CF-UF experiments. In a standard experiment, 1000 mL of CF-MF permeate dispersion was reduced to 100 mL by extracting 900 mL of ethanol/EC solution as the CF-UF permeate, such that C, =10. During filtration, a 250 mL min⁻¹ feed flow rate and a 10 mL min⁻¹ permeate flow rate were used. After concentration, the CF-UF retentate was decanted for further study.

Rotary evaporation: Solids were recovered from CF-MF and CF-UF samples after loading the retentate or permeate dispersions into a R300 rotary evaporator (BUCHI Corporation, New Castle, DE) with a 50 °C heating bath, 10 °C condenser, 250 rpm, and 70-97 mbar pressure applied to the column. Once dried, the solids were recovered by scraping the inside of the powder drying flask with a spatula and weighed. Thermogravimetric analysis (TGA) was then used to determine the relative composition of the GrEC and EC solids derived from the retentate and permeate, respectively.

Ink formulation: When preparing the printable conductive inks, CFF-0.65 permeate dispersions containing GrEC were flocculated into solid powders using 4% w/v NaCl:H₂O, collected, washed with deionized water, and dried under an infrared lamp as previously reported.

The powders were then redispersed via bath sonication in an 80:15:5 v/v mixture of cyclohexanone, terpineol, and diethylene glycol monomethyl ether (DEGME) with 2% w/v solids loading. Immediately prior to printing, the inks were fed through a glass microfiber syringe filter with a pore size of 0.70 μm. Meanwhile, for aerosol-jet printing experiments, the same CFF-0.65 GrEC powders were redispersed in ethanol at a solid loading of 1% w/v via horn sonication using a ¼″ tip at 40% amplitude for 10 min. Immediately prior to printing, the dispersion was filtered through a 3.1 μm glass microfiber syringe filter. 10% v/v terpineol was added to the ink vial, and the mixture was bath sonicated for 10 min prior to aerosolization. Prior to inkjet and aerosol-jet printing, rheology measurements of the inks were carried out at room temperature using a Physica MCR 302 rheometer (Anton Paar) equipped with a CP 25-2 fixture (diameter=25 mm, cone angle=2°).

Film deposition: Inkjet printing experiments were carried out using a DMP-2850 material printer (FUJIFILM Dimatix Inc., Santa Clara, CA) equipped with 10 pL cartridges (Product No. DMC-11610, 20.4 μm nozzle). Detailed printing protocols, including the waveform and cartridge setting files, are available on the product page for MilliporeSigma Catalog No. #793663. Aerosol-jet printing experiments were carried out using an AJ200 material printer (Optomec, Albuquerque, NM, USA) using the following parameters: platen temperature was set to 60 °C, bath temperature was set to 30 °C, print speed was set to 5 mm s⁻¹, nitrogen sheath flow was set to 60 sccm, and nitrogen carrier gas flow rate was set to 15-22 sccm with an atomization current of 0.354 mA. After printing, the specimens were heated at 350 °C for 30 minutes using a box furnace to decompose the EC binder and increase film conductivity.

Life cycle assessment and techno-economic analysis: Life cycle assessment (LCA) offers a holistic evaluation of the environmental impacts for all stages of the centrifuge-based sedimentation (CBS) and cross-flow filtration (CFF) processes in this study. The LCA methodology used here is based on ISO 14040/44 standards. Meanwhile, techno-economic analysis (TEA) examines the energy, material, and water consumption and cost performance of each graphene production process based on a material and energy flow analysis and an annualized cost approach. The functional unit used for comparison purposes is 1 g of graphene, and all costs were defined by the US dollar ($) in 2021. Furthermore, the specific production cost (Cₚ, $ g⁻¹) of graphene is calculated through an annualized cost approach, as shown in Equation 1:

$${C}_{p} = \frac{{C}_{ac} + {C}_{O \& M}}{Y} + {C}_{m} \qquad ( 1 )$$

The annualized capital costs (C_{ac}) are calculated based on process lifetime (n, years) and discount rate (r) shown in Equation 2:

$${C}_{ac} = {C}_{c} * ( \frac{r * {( 1 + r )}^{n}}{{( 1 + r )}^{n} - 1} ) \qquad ( 2 )$$

Raw material costs (Cₘ) for graphite, EC, and ethanol are determined based on a functional unit of 1 g graphene, whereas Y is the annual graphene yield. The capital costs (Cc) of the two processes are assumed to be only the equipment purchase costs in this calculation. Meanwhile, the operating and maintenance expenses (C_{O&M}) include the annual cost of consumables, electricity, and labor. All LCA and TEA parameters with full data and assumptions for graphene production are detailed in Tables 4-7.

### Characterization and Instrumentation

Compositional analysis: Concentration measurements of solution-phase CFF GrEC dispersions were carried out using a Cary UV-Visible spectrophotometer (Agilent). Spectra were collected over the wavelength range λ=300-700 nm, with the absorbance at, λ=660 nm being extracted to compute the graphene concentration as described in the main text. Meanwhile, thermogravimetric analysis (TGA) was used to determine the relative composition of solid GrEC specimens using a combined TGA/DSC 3+ system (Mettler Toledo). All measurements were performed while flowing synthetic air at 8.3×10⁻⁴ L s⁻¹ from 25 °C to 600 °C with a ramp rate of 7.5 °C min⁻¹. The mass ratio of graphene to EC was calculated at 450 °C after complete decomposition of EC.

Physicochemical characterization: For spectroscopic measurements, 2% w/v CFF GrEC powder was redispersed in a 90:10 v/v solution of ethanol:ethyl lactate. The resulting dispersions were filtered through a 1.6 μm glass microfiber syringe filter (Whatman) and spin-coated onto glass substrates. The glass substrates were solvent cleaned and exposed to ozone plasma for 2 min at medium power before deposition. After spin-coating, the films were allowed to dry in ambient conditions, and thermal decomposition of the EC polymer binder was performed in air at 350 °C for 30 min in a box furnace. Raman spectroscopy was performed on the spin-coated and thermally cured films using a LabRAM HR Evolution microscope (Horiba) equipped with a 532 nm laser at 10% power. Spectra were acquired using an acquisition time of 30 s (accumulation=3) and 2,400 g mm⁻¹ grating. X-ray photoelectron spectroscopy (XPS) was conducted with an ESCALAB 250Xi spectrometer (Thermo Fisher Scientific) with an Al Kα radiation source, a spot size of 500 m, an electron flood gun, and a scanning ion gun. The spectra were analyzed using Thermo Advantage.

Morphological characterization: The morphology of spin-coated films, printed features, lumen interiors, drop-casted dispersions, and graphite precursors was investigated with scanning electron microscopy (SEM) and optical microscopy. For SEM, a SU8030 FEG SEM (Hitachi) was the primary tool used. For highly conductive samples (e.g., GrEC films, printed features post-thermal decomposition of EC), an accelerating voltage of 5.0 kV was used. For charge-sensitive samples (e.g., PS CFF membranes), specimens were coated with 9 nm of OsO₄, and an accelerating voltage of 2.0 kV was used. Optical microscopy was performed using a Bruker microscope with a standard bulb.

Particle size analysis: To ensure representative particle size statistics were obtained, a combination of ensemble and counting-based measurements were used. For the former, a Zetasizer Nano (Malvern Instruments) was used to perform dynamic light scattering (DLS) measurements on CFF GrEC dispersions in ethanol. A refractive index of 2.700 and absorption coefficient of 1.390 were programmed into the standard operating procedure for ethanol-based dispersions. A standard backscatter angle of 173° was used across all measurements, and 12-16 scans were averaged for each measurement. Error bars correspond to the standard error of the mean for n=3 repeated measurements. From DLS, the intensity/intensity autocorrelation function, G(τ), describes the Brownian motion of constituent particles. We refer the reader to work published by Lotya et al. and Ragheb et al. cited in the main text for a detailed background of the origin of this function and its dependent variables. However, for purposes of our measurement, it can be written in a logarithmic expression (Equation 3).

ln[G(τ)−1]=lnβ-2α₁τ+2α₂τ²+ (3)
where β is the signal-to-noise ratio that measures detection efficiency and a₁ and a₂ are first- and second-order fitting terms, respectively. From this form of the DLS autocorrelation function, two metrics were analyzed: briefly, the cumulant particle size (Z-Average, Equation 4) is an intensity-weighted mean of the particle size distribution.

$${Z}_{average} = \frac{{k}_{B} {Tq}^{2}}{3 π {a}_{1}} \qquad ( 4 )$$

Here, k_{B} is Boltzmann's constant, T is the absolute temperature of the measurement, and q is the particle wave vector. Meanwhile, the polydispersity index (PDI, Equation 5) is the normalized width of a Gaussian distribution fit to the logarithmic expression of the autocorrelation function. A larger PDI corresponds to a greater variance in size for constituent particles.

$$PDI = \frac{2 {a}_{2}}{{a}_{1}^{2}} \qquad ( 5 )$$

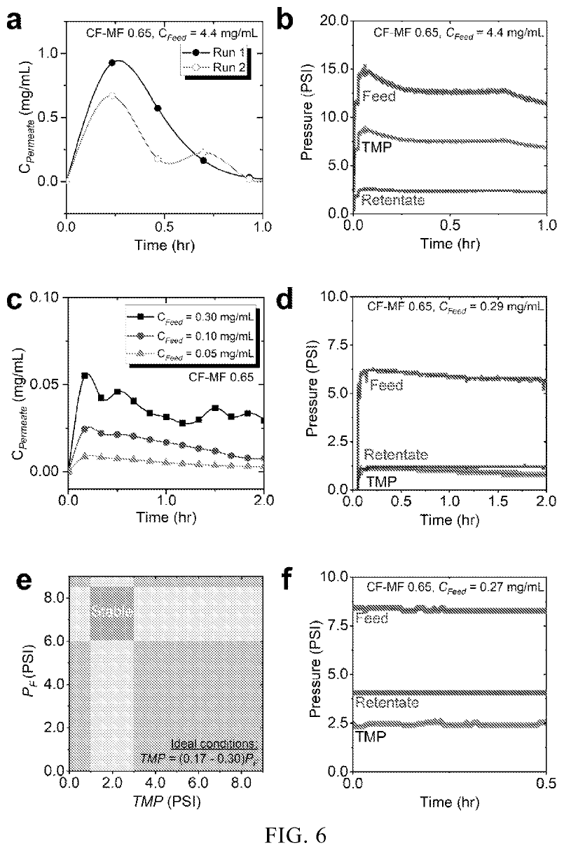

Counting-based particle size analysis of individual nanosheets was performed via atomic force microscopy (AFM) using an Asylum Cypher microscope (Oxford Instruments). Prior to drop-casting, 300 nm SiO₂/Si wafers were cleaned via bath sonication using acetone, ethanol, and isopropyl alcohol for 5 min each. The solvent-cleaned wafers were then soaked for 30 minutes in a solution of 3-aminopropyl-triethoxysilane (APTES, 0.0025 M) in isopropyl alcohol (9 mL). An aliquot of each sample (15 pL) was diluted to a concentration ~10 pg mL⁻¹ and drop-casted onto the APTES-treated wafers, followed by a 30 min baking step on a hot plate set to 400 °C to remove EC and APTES residue. Several scans were obtained with a scan area of 5 μm×5 μm, a scan rate of 0.8-1.0 Hz, and a resolution of 512 pixels/line. Micrographs were processed using open-source Gwyddion software to flatten scans and remove measurement artifacts for a more rigorous analysis. Flake parameters, such as mean flake area and thickness, were obtained using a custom MATLAB image processing script cited in the main text (“Software Availability Statement”) configured with a canny edge detection algorithm. 50-100 nanosheets were scanned for each CFF dispersion, and lateral size and thickness data fitted with a log-normal distribution (FIG. 6).

Charge transport measurements: After film deposition, the thickness of the printed features and film roughness were obtained with a Dektak stylus profilometer using a 5.0 μm stylus radius. These film thickness values were then used to determine film conductivity using a four-point resistivity probe stand (Lucas Labs), a Keithley 2400-series source meter unit, and a custom LabView virtual instrument file. The resistivity was obtained via Equation 6:

$$ρ = 2 π \times s \times a \times \frac{V}{I} \times k \qquad ( 6 )$$

where ρ is resistivity, s is probe spacing (1 mm), a and k are correction factors, and V and I are the voltage and current recorded by the source meter unit, respectively. The correction factor, k, is then calculated from the probe spacing, assuming a 3 mm×3 mm square in the measurement area according to Equation 7, such that D S=3 and k=0.62.

$$k = \frac{1}{1 + \frac{4.54957}{{( \frac{D}{S} )}^{1.83824}}} \qquad ( 7 )$$

Sheet resistance is calculated using Equation 8, where a=4.53 for thin films, and conductivity is calculated in Equation 9 using the thickness measured from stylus profilometry (t).

$${R}_{s} = a \times ( \frac{V}{I} ) \times k \qquad ( 8 )$$

$$c = \frac{1}{{R}_{s} \times t} \qquad ( 9 )$$

### Results and Discussion

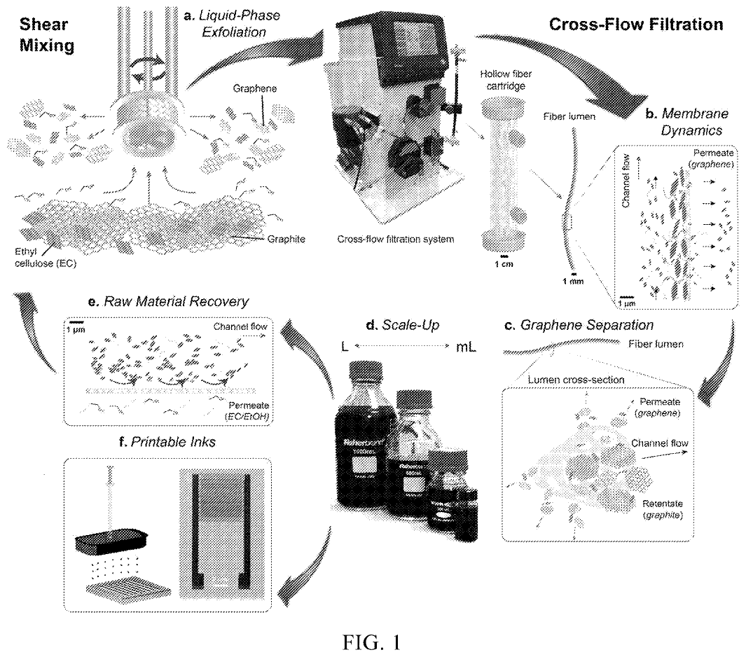

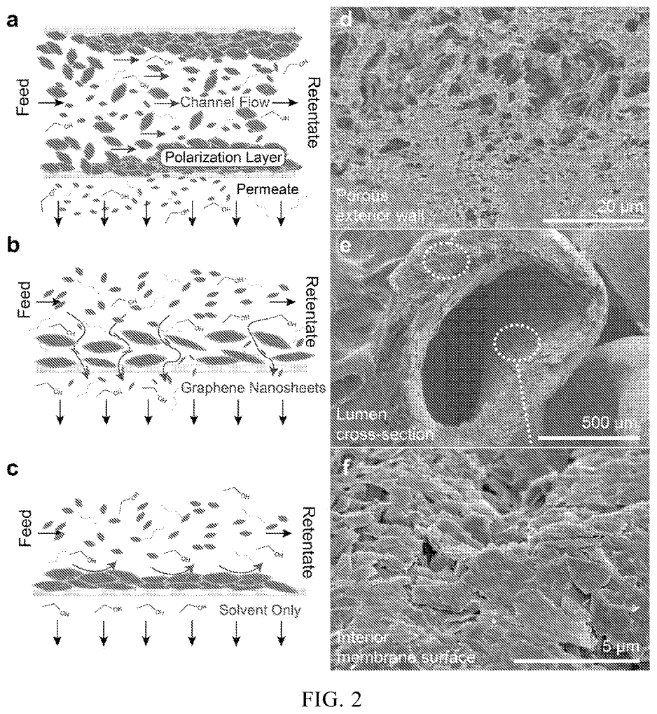

Overview: Our CFF process enables a modular energy-efficient separation scheme that is specifically tailored for graphene/EC dispersions (FIG. 1). Following LPE by shear mixing, the resulting dispersions containing poorly-exfoliated graphite, well-exfoliated graphene nanosheets, EC, and ethanol (panel a of FIG. 1) only experience natural sedimentation due to gravity prior to filtration with a CFF unit (Cytiva AKTA Flux s). This unit supports various filtration modules and offers process controls including tunable pump flow rates that directly modulate process pressures and filtration performance (panel b of FIG. 2). The filter modules used here contain bundles of hollow fiber membranes composed of hydrophobic polysulfone, which minimizes material interactions between the membrane and the feed dispersion.

For CF-MF process control, sensors are used to monitor the pressure at the feed, retentate, and permeate ports of the filter module. A peristaltic feed pump drives the process mixture through the module. A second peristaltic permeate pump facilitates collection of the permeate dispersion containing well-exfoliated graphene nanosheets, while the retentate stream containing poorly-exfoliated graphite is returned to the feed reservoir for additional passes through CF-MF. Here, the secondary pump is key for maintaining a constant flux across the membrane, given that the spontaneous flux is insufficient to facilitate passage of graphene nanosheets through the pores (panel c of FIG. 1). Provided that CF-MF is carried out under optimized processing conditions, working volumes up to 10 L can be accommodated (panel d of FIG. 1). The filters can also be washed and regenerated after each experiment with pure solvent to prolong their lifetime.

The microfiltration permeate stream from CF-MF is sent into CF-UF (pore size is ~10 nm), which enables recovery and recycling of ethanol and EC via the CF-UF permeate (panel e of FIG. 1). Meanwhile, the CF-UF retentate is enriched to an even more concentrated dispersion of monodisperse graphene nanosheets as ethanol/EC are removed. The monodisperse graphene nanosheets from the CF-MF permeate/CF-UF retentate can then be used for high-performance applications such as printable conductive inks. Regarding material quality, we note that measures of quality or utility of LPE graphene vary widely in the literature depending on the targeted application. For this reason, we focused on printable conductive inks (panel f of FIG. 1) for our demonstration of CFF as a 2D material processing method due to a clearly defined figure of merit (i.e., the electrical conductivity of the printed graphene film) in addition to the sensitivity of electronic properties to graphene nanosheet size monodispersity.

Membrane Dynamics and Process Control: During CF-MF, we found that the anisotropic shape of the graphene nanosheets led to a deviation from the previously reported membrane fouling behavior of other nanoparticles that have been processed with CFF.^{[20,30]} This deviation presented a challenge to identify the optimal operating regime to mitigate fouling of solution-exfoliated 2D nanosheets. We began by targeting a membrane flux value compatible with CF-MF membranes rated with a pore size of 0.65 μm (Table 1).

In CFF, flux (J) is the critical parameter dictating separation performance, with higher flux offering improved process throughput. In Equation 10, J is defined as the volume of solution passing through the membrane area per unit time in units of L m⁻² h⁻¹.

$$J = μ \frac{TMP}{{R}_{g} + {R}_{m} + {R}_{c}} \qquad ( 10 )$$

where μ is viscosity, TMP is the transmembrane pressure, and R_{g}, Rₘ, and R_{c} correspond to the gel boundary/polarization layer resistance, membrane resistance, and concentration boundary resistance on the membrane, respectively. Since it is challenging to quantitatively measure these resistances, TMP is the most readily available and useful parameter for optimizing Jin our system. Identifying a stable TMP window is crucial for prolonged effectiveness of CF-MF because a reduction in TMP corresponds to declining flux. We performed process optimization by varying the feed concentration and feed flow rate as independent variables (Table 2), with graphene concentration in the permeate stream and pressure sensor readings serving as dependent variables used to calculate TMP.

This optimization identified an ideal combination of high channel flow rate, low permeate flow rate, and low feed concentrations (FIG. 2) Under these conditions, the channel flow provides a sweeping effect that dislodges poorly exfoliated graphitic particles and minimizes the formation of a dense polarization layer at the membrane surface (panel a of FIG. 2). In this stable operating regime, the polarization layer remains sufficiently porous to allow cross-flow of graphene nanosheets into the permeate stream (panel b of FIG. 2). On the other hand, once a dense polarization layer accumulates, only solvent molecules can penetrate the membrane surface (panel c of FIG. 2). To visualize the polarization layer, a representative CF-MF lumen was imaged with scanning electron microscopy (SEM) following prolonged graphene separation (panel d of FIG. 2). SEM reveals a highly open microstructure at the exterior surface of the lumen (panel e of FIG. 2), whereas the interior lumen surface is coated with a dense polarization layer of graphitic particles (panel f of FIG. 2).

TABLE 1
Membrane attributes for cross-flow
filtration of graphene dispersions

| | | Cross-Flow | Cross-Flow | Cross-Flow |
|---|---|---|---|---|
| | | Micro- | Micro- | Ultra- |
| | | filtration | filtration | filtration |
| Filter Attributes | Unit | (V = 0.5 L) | (V = 10 L) | (V = 0.5 L) |
| Pore size | μm | 0.65 | 0.65 | 0.010-0.012 |
| Fiber count | — | 20 | 300 | 13 |
| Fiber inner | mm | 0.75 | 0.75 | 1.0 |
| diameter | | | | |
| Module length | cm | 33.7 | 31.8 | 33.7 |
| Membrane | cm² | 120 | 1,600 | 110 |
| surface area | | | | |

TABLE 2
Process parameters for cross-flow
filtration of graphene dispersions.

| | | Cross- | Cross- | Cross- |
|---|---|---|---|---|
| | | Flow | Flow | Flow |
| | | Micro- | Micro- | Ultra- |
| | | filtration | filtration | filtration |
| Process Parameter | Unit | (V = 0.5 L) | (V = 10 L) | (V = 0.5 L) |
| Flux set | L m⁻² h⁻¹ | 25 | 56-129 | 55 |
| point (J) | | | | |
| Lumen shear | s⁻¹ | 8,000 | 16,000 | 4,000-5,000 |
| rate (γ_{w}) | | | | |
| Feed flow rate | L min⁻¹ | 0.343 | 11.928 | 0.200 |
| Permeate | L min⁻¹ | 0.005 | 0.149-0.344 | 0.010 |
| flow rate | | | | |

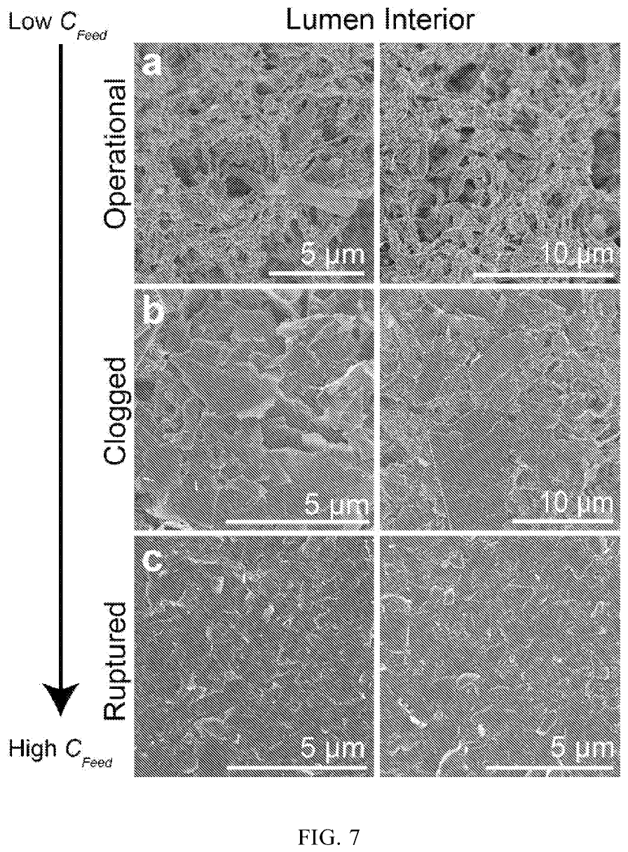

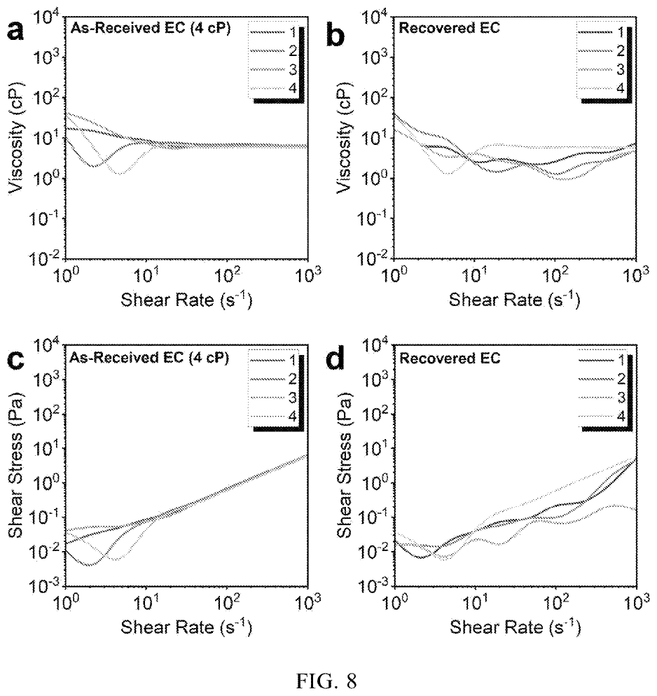

In addition to determining flow rate conditions that lead to a large and stable TAINP, the GrEC feed concentration (C_{Feed}) must be optimized for efficient and prolonged CF-MF. Successful separation of exfoliated graphene dispersions was initially possible without dilution, but rapid fouling occurred along with a sharp decline in TMP (panels a-b of FIG. 7). This decline in TA/IP can be attributed to the formation of a dense polarization layer (FIG. 8). After diluting C_{Feed} to 0.30 mg/mL with pure ethanol, minimal fouling was observed, and the TMP remained stable at ~1 PSI for hours (panels c-d of FIG. 7). In summary, we found TMP=(0.17-0.30)P_{f} to be the ideal pressure window for CF-MF, where P_{f} is the feed pressure (FIG. 6).

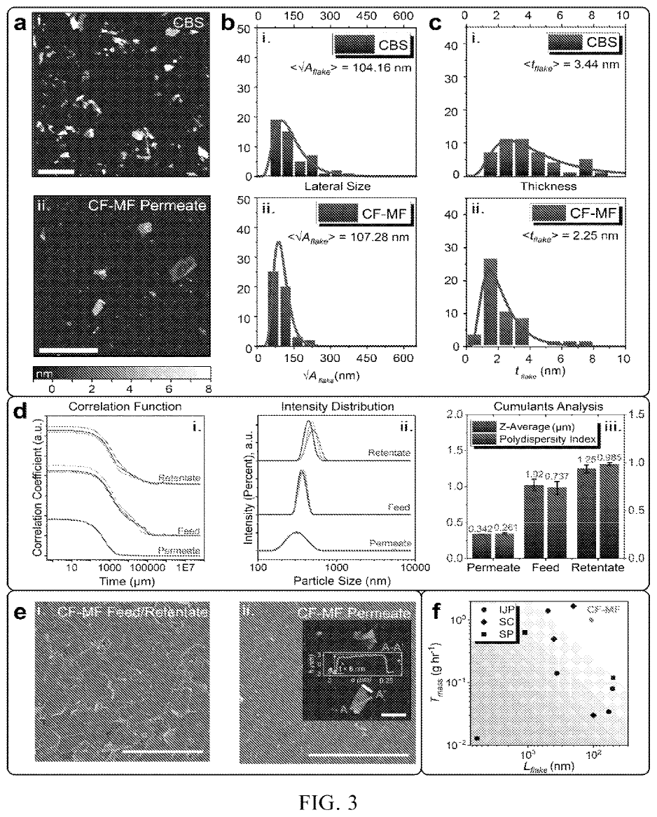

Characterization of Graphene Nanosheets Separated by Cross-Flow Microfiltration: The size of the graphene nanosheets separated by CF-MF was characterized with a combination of microscopy and light scattering techniques (FIG. 3). First, atomic force microscopy (panel a of FIG. 3) was used to obtain distributions of nanosheet length values (panel b of FIG. 3)—defined here as the square root of the flake area (√A_{flake})—along with flake thickness (t_{flake}, panel c of FIG. 3). From AFM of the centrifuge-based separation (CBS) control sample, we found that <√A_{flake}>=104.2 nm and <t_{flake}>=3.4 nm. Meanwhile, from the CF-MF permeate, CFF graphene nanoflakes exhibited comparable sizes of <√A_{flake}>=107.3 nm and <t_{flake}>=2.3 nm (n=50-100).

Dynamic light scattering (DLS) was also employed for rapid screening of CF-MF process streams (panel d of FIG. 3). Although the nominal sizes obtained via DLS are quantitatively unreliable for anisotropic nanoparticles, DLS still provides a relative comparison of the size scale of CF-MF process streams. Successive measurements of the particle size distributions indicated a shift towards smaller particle sizes after CF-ME. Meanwhile, the autocorrelation functions of the coarse feed and retentate dispersions showed evidence of aggregates, with evident variability between repeated measurements that is consistent with high polydispersity.

Here, we quantify monodispersity using two metrics from DLS analysis: the cumulant particle size (Z-Average) and polydispersity index (PDI), both of which are derived for colloidal materials by Ragheb et al. The centrifuged control sample processed at ~10,500 rcfexhibited Z-Average=273 nm and PDI=0.179. Based on this result and the findings of Ragheb et al., we set Z-Average=400 nm and PDI=0.300 as the criteria for monodispersity. Notably, the DLS analysis values are highest for the retentate, showing an enrichment in poorly exfoliated graphite (panel d of FIG. 3, iii.) In contrast, the CF-MF permeate dispersion of graphene nanosheets shows the lowest Z-Average=342 nm and PDI=0.261, meeting the monodispersity criteria.

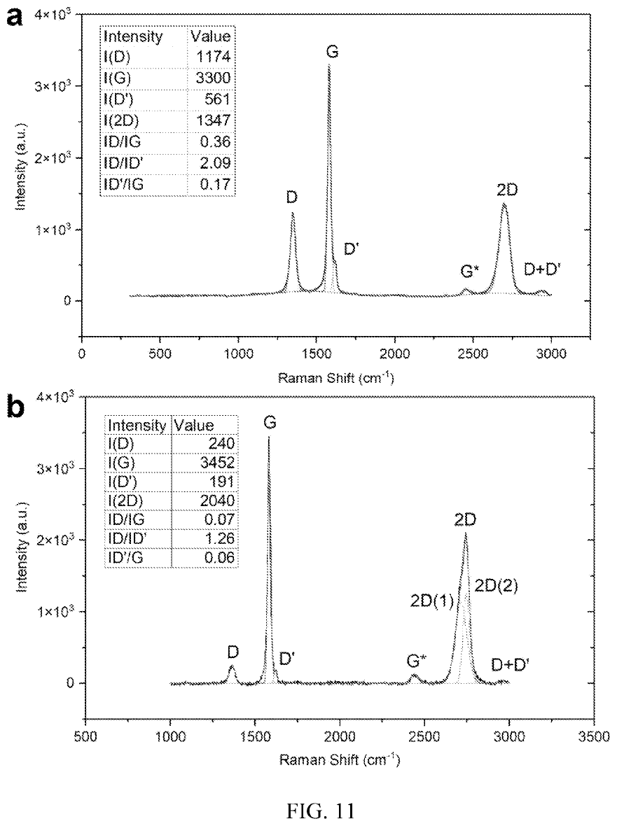

To further illustrate that our DLS analysis threshold is a predictor of downstream material performance, we spin-coated and compared the conductivity of graphene films from the retentate and feed streams of CF-MF. The retentate sample, which had PDI>0.300 and Z-Average>400 nm, also exhibits an inferior film conductivity of c=3.34×10³ S/m compared to the CF-MF permeate samples (c=2.03×10⁴ S m⁻¹). Finally, Raman spectroscopy of the constituent films (FIG. 11) shows a shoulder on the 2D peak in the retentate-derived film that is characteristic of microcrystalline graphite versus the narrow, symmetric 2D band in the permeate-derived film.

To demonstrate scalability, the CF-MF process was then translated to the pilot scale with an apparatus built in-house that increased the membrane area 10-fold and the processing volume 20-fold, all while keeping the filter material, pore size, and C_{Feed} constant (Tables 1 and 2). The pilot-scale apparatus also utilized high-flow peristaltic pumps that the volumetric throughput (T_{volumetric}) to increase to 15 L hr⁻¹. This throughput represents a ~2 orders of magnitude advantage compared to conventional centrifugation. At the pilot scale, we also observed higher TMP stability, particularly that ~1 gallon of graphene dispersion could be processed in 15 min (FIG. 6)

Since ultimately the output graphene mass per unit time is the most important scalability metric for graphene manufacturing, the mass throughput (Tₘₐₛₛ) versus the lateral size of separated graphene flakes (L_{flake}) is compared between this work and previously reported separation approaches in panel f of FIG. 3. Here, “SC”=spin-coating, “SP”=screen printing, and “IJP”=inkjet printing; these material printing techniques will be revisited in a subsequent section. For this comparison, L_{flake} is based on the graphene flake length determined by microscopy using the optimal centrifugation conditions specified by the authors (i.e., the reported best result for the target application). Each of these prior works had also successfully printed graphene into thin films with electrical conductivities>10³ S m⁻¹ as summarized in Table 3. Overall, this comparison shows that CF-MF is state-of-the-art in terms of Tₘₐₛₛ.

TABLE 3
Comparison of separation throughput for printable, solution-processed graphene.

| | LPE | Conductivity | Print | L_{flake} | T_{volumetric} | Tₘₐₛₛ |
|---|---|---|---|---|---|---|
| Author | Stabilizer | (S m⁻¹) | Method^{a)} | (nm) | (L hr⁻¹) | (g hr⁻¹) |
| Lund et al. | NaC | 17000 | SC | 100 | 0.010 | 0.030 |
| Kim et al. | EC | 14900 | SP | 1100 | 0.013 | 0.633 |
| Tkachev et al. | None | 22989 | SC | 200 | 0.451 | 1.67 |
| | (cyrene) | | | | | |
| Gudarzi et al. | Pyrene | 310000 | SP | 6000 | 0.257 | 0.013 |
| Secor et al. | EC | 25000 | IJP | 51 | 0.80 | 0.080 |
| Pan et al. | CAB | 37000 | SP | 50 | 0.012 | 0.120 |
| Carey et al. | SDC | 15000 | IJP | 492 | 0.238 | 1.40 |
| del Rio Castillo et | None | 1300 | IJP | 360 | 0.456 | 0.141 |
| al. | (NMP) | | | | | |
| Jeong et al. | Ionic | 9325 | IJP | 58 | 0.142 | 0.034 |
| | liquid | | | | | |
| Large et al. | Triton-X | 50000 | SP | 400 | 0.758 | 0.500 |
| This Work | EC | 21000 | IJP | 107 | 15.1 | 1.01 |

^{a)a)}SP = screen printing; SC = spray-coating; IJP = inkjet printing.

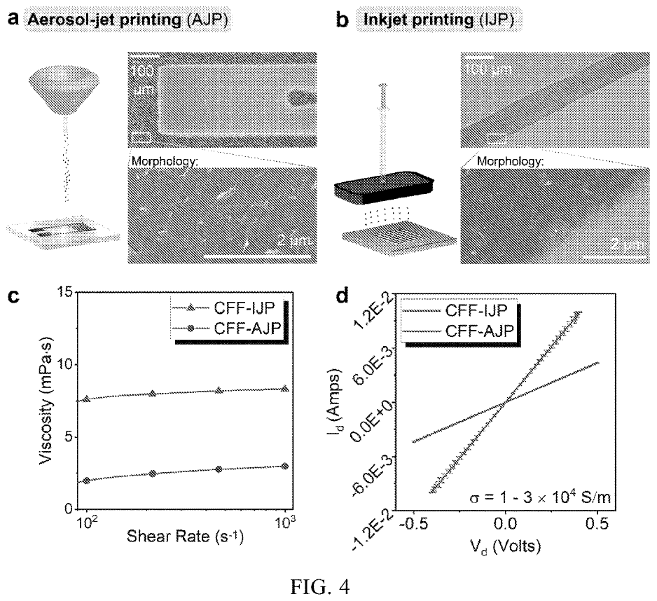

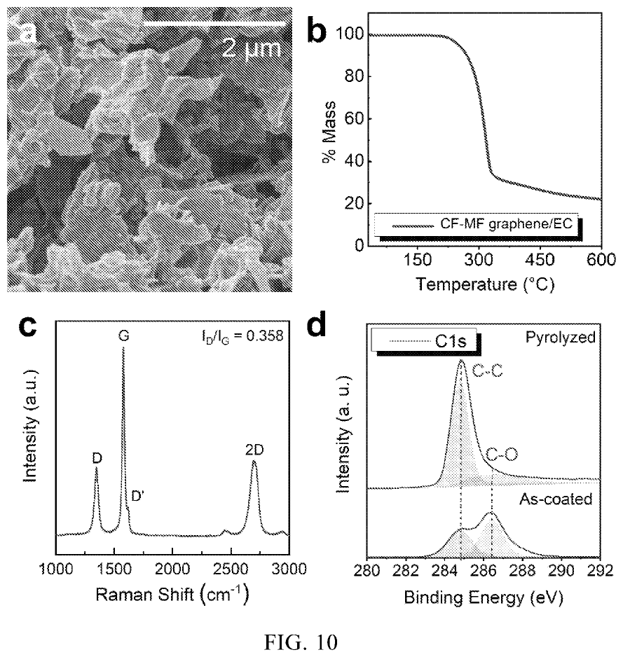

Cross-Flow Ultrafiltration for Material Recycling: Following separation of graphene, additional processing steps are still required to isolate graphene nanosheets including centrifuge-based flocculation, rinsing, and solvent removal. Upon implementation of pilot-scale CF-MF, these post-separation processing steps become the bottleneck in the production of graphene nanosheets. Therefore, we explored the use of hollow fiber membranes with nanoscale pore sizes rated for cross-flow ultrafiltration (CF-UF) to selectively remove ethanol and EC from the CF-MF permeate. This approach not only facilitates efficient removal and recycling of ethanol and EC but also simplifies post-separation processing. Since the molecular weight of 4 cP EC is approximately 20 kDa CF-UF filter modules were tested with a nominal molecular weight cutoff of 500-750 kDa (approximately 10.9-12.5 nm. As shown in the process flow schematic shown in panel a of FIG. 4, the CF-MF permeate becomes the feed dispersion for CF-UF, with ethanol and EC then traversing the CF-UF membrane into the CF-UF permeate. Subsequently, rotary evaporation allows for separation and recovery of ethanol and EC, with the recycled EC showing a viscosity comparable to the EC raw material (FIG. 10). This result suggests that minimal EC polymer scission occurred during shear mixing and subsequent CFF processing, allowing it to be reused for additional graphene exfoliation.

The retentate from the CF-UF process is a concentrated dispersion of graphene nanosheets. The volumetric concentration factor (C) depends on the volume of feed dispersion (V_{feed, initial}) and the volume of permeate dispersion (Vₚₑᵣₘₑₐₜₑ) collected from the CF-UF permeate as shown in Equation 11:

$${C}_{v} = \frac{{V}_{feed , initial}}{( {V}_{feed , initial} - {V}_{permeate} )} \qquad ( 11 )$$

The CF-UF experiments targeted Cᵥ=10. Afterwards, the concentrated CF-UF retentate was flocculated into a solid powder for comparison with a control sample of the CF-MF permeate that did not undergo CF-UF. Thermogravimetric analysis (TGA) of the flocculated GrEC powders showed that after CF-UF, the mass ratio of graphene to EC increased from 40 wt. % to 60 wt. % (FIG. 11), thus confirming that excess EC was removed during the CF-UF. Overall, the sequential application of cross-flow microfiltration and ultrafiltration offers a dual-function, continuous-flow processing scheme for (1) isolating monodisperse graphene nanosheets and (2) recovering ethanol and EC for reuse. In previous demonstrations of CFF, at least one of the process streams is discarded as waste. In contrast, we have utilized all three CFF process streams to not only isolate graphene nanosheets but also to recycle poorly-exfoliated graphite, EC, and ethanol.

Electronic Performance of Graphene Nanosheets Following Cross-Flow Filtration: For this work, we are defining graphene quality by its downstream performance in electronic-grade films, which have a reliable figure of merit (i.e., film conductivity) that is easily compared across applications. It should be noted that multi-layer graphene nanoflakes with sizes comparable to our CFF-derived graphene comprise the highest market fraction for graphene and its derivatives (i.e., 52% of the global graphene market, projected at $180 million as of 2022).

The CFF-derived GrEC powder shown in panel a of FIG. 12 was formulated into printable conductive inks to assess the electronic performance of the graphene nanosheets (FIG. 4). Conductive graphene inks were prepared and tested for aerosol-jet printing (AJP, panel a of FIG. 4) and inkjet printing (IJP, panel b of FIG. 4) using formulations adapted from previous reports. Specifically, the AJP and IJP inks employed a 90:10 ratio of ethanol:terpineol and an 80:15:5 ratio of cyclohexanone:terpineol:diethylene glycol monomethyl ether (DEGME), respectively. Rheological measurements indicate that the IJP ink is more viscous than the AJP ink, as expected (panel c of FIG. 4).

After printing, the substrates were thermally cured in ambient conditions at 350 °C for 30 min to decompose the EC binder. Following curing, the film conductivity was measured to be >10⁴ S m⁻¹ for both inks (panel d of FIG. 4), which is consistent with previous results. Optical microscopy confirmed well-defined printed features, and SEM showed the formation of dense, percolating films for both IJP and AJP. While the GrEC powders used to formulate each ink were compositionally identical (panel b of FIG. 12), the AJP printed features showed marginally lower conductivity due to the formation of rougher graphene films by aerosolization.

Spectroscopic characterization of CFF-derived films further confirmed the physicochemical characteristics of high-quality graphene. For example, Raman spectroscopy performed after thermal decomposition of EC (panel c of FIG. 12) indicates the characteristic D (1348.48 cm⁻¹), G (1579.9 cm⁻¹), and 2D (2698.8 cm⁻¹) peaks of graphene. A Gaussian fit of the Raman spectrum reveals full-width at half-maximum (FWHM) values of 42.8 cm⁻¹, 25.3 cm⁻¹, and 80.4 cm⁻¹ for the D, G, and 2D peaks, respectively, and an I_{D}I_{G} ratio of 0.354. (FIG. 13) These values are consistent with prior reports of graphene nanosheets exfoliated in ethanol with EC. To further justify the quality of the printed material, we note that graphene nanoflake films with similar metrics have performed well in printed electronic applications including an aerosol-jet-printed COVID-19 immunosensor (I_{D}/I_{G}~0.33 and FWHM(2D) ~80 cm⁻¹). X-ray photoelectron spectroscopy (XPS) (panel d of FIG. 12) characterization further confirms high-quality graphene nanosheets that are consistent with prior reports. Overall, these results confirm that CFF-derived graphene nanosheets are physically and chemically equivalent to traditional centrifuge-based processing, which implies that they can be directly employed in high-performance graphene applications.

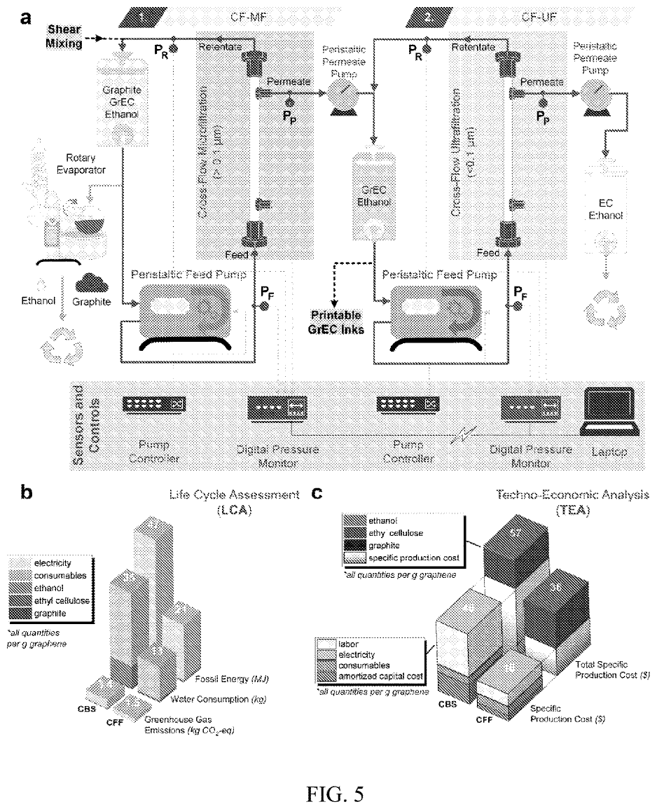

Life Cycle Assessment and Techno-Economic Analysis: Significant drawbacks of the incumbent centrifuge-based separation (CBS) approach for 2D nanosheet separation include its significant capital equipment costs, labor requirements, and energy consumption. Using a functional unit of 1 g of graphene, we performed a holistic comparison of the CFF/CBS separation processes using life cycle assessment (LCA) to evaluate CFF sustainability gains for scale-up (FIG. 5). This analysis was based on the integration of cross-flow microfiltration and ultrafiltration depicted in panel a of FIG. 5 (“CFF”) and conventional CBS paired with CF-UF for ethanol/EC recycling.

Regarding key assumptions, we note that to ensure the most objective comparison possible, we only considered instrument runtime (i.e., not cleaning time) in the calculations for yield and throughput. Based on our experimentation, the CFF module lifetime is approximately 6 weeks. Thus, we have overestimated an annual inventory of 10 CFF modules weighing ~270 g each. Environmental and techno-economic parameters from the literature are presented in Table 4, and inventory of materials in Table 5. Tabulated results of environmental impacts per 1 g of graphene are provided in Table 6.

TABLE 4
Environmental and techno-economic parameters.

| Parameter | Unit | Value |
|---|---|---|
| CO₂ GWP₁₀₀ | g CO₂- | 1 |
| | eq/g | |
| CH₄ GWP₁₀₀ | g CO₂- | 30 |
| | eq/g | |
| N₂O GWP₁₀₀ | g CO₂- | 265 |
| | eq/g | |
| Primary energy | MJ/kg | 3.08 |
| requirement for steam | | |
| US average electricity cost | $/MJ | 0.043 |
| US median hourly wage | $/h | 20.17 |
| Discount rate ^{a)} | % | 10 |
| Process lifetime | years | 20 |

^{a)} The discount rate was set to 10% for industrial and commercial projects, such that the annualized capital costs will increase 6.9% with a 1% increase in the discount rate.
^{b)}

TABLE 5
Inventory for production of 1 g graphene.

| Input | Unit | CBS Values^{a)} | CFF Values^{a)} |
|---|---|---|---|
| Graphite | g | 1.0 | 1.0 |
| Ethyl cellulose | g | 16 | 21 |
| Ethanol | g | 193 | 0.0 |
| Centrifuge bottles | g | 1.9 | 0.0 |
| (polypropylene) | | | |
| Filters (mPES, epoxy, PE) | g | 1.3 | 1.9 |
| Tubing (silicone) | g | 1.1 | 1.6 |
| Electricity | MJ | 19 | 8.8 |
| Graphite | g | 1.0 | 1.0 |

^{a}These quantities do not consider material that can be recovered and reused via recycling (e.g., 100 g of graphite is fed into the system, but 99% is recovered via downstream processing, hence the graphite inventory is 1 g).

TABLE 6
Environmental impacts calculated per kg input.

| | | Value for each input | | | | | | |
|---|---|---|---|---|---|---|---|---|
| | | Natural | Ethyl | | Centrifuge | | | |
| Impact | Unit | graphite | cellulose | Ethanol | bottles^{a)} | Filters^{b)} | Tubing^{c)} | Electricity |
| Fossil | MJ/kg | 106 | 8.2 | 15 | 73 | 162 | 109 | 2.3 |
| energy | | | | | | | | (MJ/MJ) |
| Water | kg/kg | 41 | 25 | 40 | 7.8 | 20 | 45 | 1.4 |
| consumption | | | | | | | | (kg/MJ) |
| Global | g | 3500 | 330 | 1461 | 2200 | 10000 | 11710 | 164 |
| warming | CO₂- | | | | | | | (g CO₂- |
| potential | eq/kg | | | | | | | eq/MJ) |

^{a)}PP;
^{b)}mPES, epoxy, PE;
^{c)}silicone

Techno-economic analysis (TEA) further illustrates the economic benefits of CFF compared to CBS, with specific production costs being reduced by 72% before material costs are included and still being reduced by 37% including materials (panel c of FIG. 5). The primary drivers for the economic advantage of CFF are reduced labor costs and amortized capital equipment costs. Although the materials costs are currently higher for CFF, further optimization of the recycling step is likely to address this issue, resulting in additional improvements in the total specific production cost of graphene via CFF.

Life cycle assessment (LCA) calculations for greenhouse gas emissions, fossil energy usage, and water consumption reveal reductions of 57%, 56%, and 63%, respectively, for CFF compared to conventional CBS processing (panel b of FIG. 5 and Tables 4-7). Lower electricity consumption with the CFF is an important driver behind its lower greenhouse gas emissions and fossil energy usage. In addition, the ability of the CFF to recycle ethanol reduces water consumption due to the wet milling that is used in modern ethanol production. Although the CBS offers higher material efficiency due to the additional dilution required for the CFF between the exfoliation and CF-MF steps, the environmental impacts of material consumables together account for less than 500 of the total environmental effects of graphene manufacturing by either process. Techno-economic analysis (TEA) further shows the economic benefits of the CFF compared to the CBS with specific production costs being reduced by 52%, as shown in panel c of FIG. 4. The primary drivers for the economic advantage of CFF over CBS are reduced labor costs and amortized capital equipment costs (Table 7). Although the materials costs are currently higher for the CFF than the CBS, further optimization of the CF-UF recycling step is likely to address this issue, resulting in additional improvements in the total specific production cost of graphene via the CFF.

TABLE 7
Parameters related to economic performance.

| Parameter | | Unit | CBS | CFF |
|---|---|---|---|---|
| Total processing time | | hr | 1.25 | 0.67 |
| Labor time | | hr | 0.75 | 0.17 |
| Runs per day | | — | 9 | 16 |
| Runs per year | | — | 3285 | 5840 |
| Annual graphene yield | | g | 2010.42 | 2829.36 |
| | | graphene | | |
| Equipment | Centrifuge | — | 2 | — |
| counts in | Rotor | — | 2.86 | — |
| process | Pump system | — | 1.14 | 2.28 |
| lifetime^{a)} | Digital pressure | — | 2 | 4 |
| | monitors and sensors | | | |
| | Rotary evaporator | — | — | 2 |
| | Infrared lamp | — | 17.52 | |

We assume that both processes can run continuously up to 12 hours per day and 365 days per year. For the purpose of determining equipment counts over the theoretical process lifetime (20 years), the lifetime for the individual pieces of equipment is sourced from manufacturer data and literature: the centrifuge lifetime is ten years; the rotor lifetime is seven years; the pump system lifetime is 17.5 years; the digital pressure monitors and sensor lifetime is ten years; the rotary evaporator lifetime is ten years; and the infrared lamp lifetime is 5,000 hours.

### CONCLUSION

In this work, we have demonstrated a continuous-flow, high-throughput, and energy-efficient post-exfoliation graphene separation process based on cross-flow filtration (CFF). Specifically, we have inverted the traditional CFF paradigm by isolating the permeate containing size-refined 2D materials, whereas previous reports collected the retentate and discarded the permeate. Furthermore, by changing the membrane pore size from the microfiltration to the ultrafiltration regime, our CFF process not only addresses the centrifugal separation bottleneck for solution-exfoliated graphene but also facilitates recovery and recycling of excess solvents and stabilizing polymers. This CFF process features a polydisperse, shear-mixed mixture flowing tangentially to the surface of a porous membrane, minimizing material buildup on the membrane surface and avoiding entrapment of larger particles in the membrane interior. In CF-MF, graphene nanosheets traverse the membrane pores via cross-flow for collection in a monodisperse, nanoscale permeate dispersion. These permeate graphene nanosheets show comparable size characteristics and electrical conductivity to centrifuged samples, but with orders of magnitude improvement in manufacturing throughput. Our sequential use of cross-flow microfiltration (CF-MF) and cross-flow ultrafiltration (CF-UF) allows us to not only isolate 2D materials, but also to harvest other raw materials for reuse (e.g., poorly exfoliated bulk material, solvent, and stabilizer molecules), which are typically discarded. This combined approach further differentiates our work from prior reports and offers major sustainability advantages. In particular, integrated CF-MF and CF-UF results in reduction of greenhouse gas emissions, fossil energy usage, water consumption, and specific production costs by 57%, 56%, 63%, and 72%, respectively. Since this methodology is based purely on separation by size (as opposed to chemical composition or other materials properties), it should be generalizable to other 2D materials, thus enabling sustainable manufacturing for the broad class of van der Waals layered solids.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described to explain the principles of the invention and their practical application to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Novoselov, K. S. et al. A roadmap for graphene. Nature 490, 192-200 (2012).
[2]. Splendiani, A. et al. Emerging photoluminescence in monolayer MoS₂. Nano Lett. 10, 1271-1275 (2010).
[3]. Jo, I. et al. Thermal conductivity and phonon transport in suspended few-layer hexagonal boron nitride. Nano Lett. 13, 550-554 (2013).
[4]. Coleman, J. N. et a!. Two-dimensional nanosheets produced by liquid exfoliation of layered materials. Science 331, 568-571 (2011).
[5]. Paton, K. R. et al. Scalable production of large quantities of defect-free few-layer graphene by shear exfoliation in liquids. Nat. Mater. 13, 624-630 (2014).
[6]. Del Rio Castillo, A. E. et al. High-yield production of 2D crystals by wet-jet milling. Mater. Horiz. 5, 890-904 (2018).
[7]. Kong, W. et al. Path towards graphene commercialization from lab to market. Nat. Nanotechnol. 14, 927-938 (2019).
[8]. Hu, G. et al. A general ink formulation of 2D crystals for wafer-scale inkjet printing. Sci. Adv. 6, 5029-5041 (2020).
[9]. Williams, N. X., Bullard, G., Brooke, N., Therien, M. J. & Franklin, A. D. Printable and recyclable carbon electronics using crystalline nanocellulose dielectrics. Nat. Electron. 4, 261-268 (2021).
[10]. Hu, G. et al. Functional inks and printing of two-dimensional materials. Chem. Soc. Rev. 47, 3265-3300 (2018).
[11]. Kelly, A. G., O'Suilleabhain, D., Gabbett, C. & Coleman, J. N. The electrical conductivity of solution-processed nanosheet networks. Nat. Rev. Mater. 7, 217-234 (2021).
[12]. Backes, C. et al. Guidelines for exfoliation, characterization and processing of layered materials produced by liquid exfoliation. Chem. Mater. 29, 243-255 (2017).
[13]. Zhu, J. et al. Solution-processed dielectrics based on thickness-sorted two-dimensional hexagonal boron nitride nanosheets. Nano Lett. 15, 7029-7036 (2015).
[14]. Backes, C. et al. Production of highly monolayer enriched dispersions of liquid-exfoliated nanosheets by liquid cascade centrifugation. ACS Nano 10, 54 (2016).
[15]. Carey, T. et al. Cyclic production of biocompatible few-layer graphene ink with inline shear-mixing for inkjet-printed electrodes and Li-ion energy storage. npj 2D Mater. Appl. 6, 3 (2022).
[16]. Fedotov, P. S., Vanifatova, N. G., Shkinev, V. M. & Spivakov, B. Y. Fractionation and characterization of nano- and microparticles in liquid media. Anal. Bioanal. Chem. 400, 1787-1804 (2011).
[17]. Svarovsky, L. Solid-Liquid Separation 4^{th} edn, 10-29 (Elsevier, 2001).
[18]. Robertson, J. D. et al. Purification of nanoparticles by size and shape. Sci. Rep. 6, 27494 (2016).
[19]. Williams, S. K. R., Runyon, J. R. & Ashames, A. A. Field-flow fractionation: addressing the nano challenge. Anal. Chem. 83, 634-642 (2010).
[20]. Zhou, H. et al. Independent thickness and lateral size sorting of two-dimensional materials. Sci. China Mater. 64, 2739-2746 (2021).
[21]. Moeser, G. D., Roach, K. A., Green, W. H., Hatton, T. A. & Laibinis, P. E. High-gradient magnetic separation of coated magnetic nanoparticles. AIChEJ 50, 2835-2848 (2004).
[22]. Chen, J. et al. Size fractionation of graphene oxide sheets via filtration through track-etched membranes. Adv. Mater. 27, 3654-3660 (2015).
[23]. Akthakul, A., Hochbaum, A. I., Stellacci, F. & Mayes, A. M. Size fractionation of metal nanoparticles by membrane filtration. Adv. Mater. 17, 532-535 (2005).
[24]. Richardson, J. F. & Harker, J. H. Chemical Engineering, Vol. 2: Particle Technology and Separation Processes 5^{th} edn, 437-474 (Butterworth-Heinemann, 2002).
[25]. Belfort, G., Davis, R. H. & Zydney, A. L. The behavior of suspensions and macromolecular solutions in crossflow microfiltration. J. Membr. Sci. 96, 1-58 (1994).
[26]. Field, R. W., Wu, D., Howell, J. A., & Gupta, B. B. Critical flux concept for microfiltration fouling. J. Membr. Sci. 100, 259-272 (1995).
[27]. Lin, Y.-T., Sung, M., Sanders, P. F., Marinucci, A. & Huang, C. P. Separation of nano-sized colloidal particles using cross-flow electro-filtration. Sep. Purif Technol. 58, 138-147 (2007).
[28]. Pradel, K. C., Sohn, K. & Huang, J. Cross-flow purification of nanowires. Angew. Chem. Int. Ed. 50, 3412-3416 (2011).
[29]. Ohmori, S., Saito, T., Shukla, B., Yumura, M. & Iijima, S. Fractionation of single wall carbon nanotubes by length using cross flow. ACS Nano 4, 3606-3610 (2010).
[30]. Yim, S. G. et al. Size fractionation of fluorescent graphene quantum dots using a cross-flow membrane filtration system. Nanomaterials 8, 1-11 (2018).
[31]. Tolle, F. J., Gamp, K. & MUlhaupt, R. Scale-up and purification of graphite oxide as intermediate for functionalized graphene. Carbon 75, 432-442 (2014).
[32]. Li, C., Guo, Y., Shen, L., Ji, C. & Bao, N. Scalable concentration process of graphene oxide dispersions via cross-flow membrane filtration. Chem. Eng. Sci. 200, 127-137 (2019).
[33]. Abdel-Motagaly, A. T., El Rouby, W. M. A., El-Dek, S. I., El-Sherbiny, I. M. & Farghali, A. A. Fast technique for the purification of as-prepared graphene oxide suspension. Diam. Relat. Mater. 86, 20-28 (2018).
[34]. Liang, Y. T. & Hersam, M. C. Highly concentrated graphene solutions via polymer enhanced solvent exfoliation and iterative solvent exchange. J. Am. Chem. Soc. 132, 17661-17663 (2010).
[35]. de Moraes, A. C. M. et al. Elucidating charge transport mechanisms in cellulose-stabilized graphene inks. J. Mater. Chem. C 8, 15086-15091 (2020).
[36]. Farraj, S. A., Jabari, E., Naguib, H. E. & Chu, T. Y. Computational modeling of graphene-ethyl cellulose printed ink: A reactive molecular dynamic study. FLEPS 2021-IEEE International Conference on Flexible and Printable Sensors and Systems, DOI. 10.1109/FLEPSS1544.2021.9469752 (2021).
[37]. Lotya, M., Rakovich, A., Donegan, J. F. & Coleman, J. N. Measuring the lateral size of liquid-exfoliated nanosheets with dynamic light scattering. Nanotechnology 24, 265703 (2013).
[38]. Ragheb, R. & Nobbmann, U. Multiple scattering effects on intercept, size, polydispersity index, and intensity for parallel (VV) and perpendicular (VH) polarization detection in photon correlation spectroscopy. Sci. Rep. 10, 21768 (2020).
[39]. Andersson, H., Hjartstam, J., Stading, M., Von Corswant, C. & Larsson, A. Effects of molecular weight on permeability and microstructure of mixed ethyl-hydroxypropyl-cellulose films. Eur. J. Pharm. Sci. 48, 240-248 (2013).
[40]. Guo, L. & Santschi, P. H. Environmental Colloids and Particles: Behaviour, Separation and Characterisation, 159-221 (John Wiley & Sons, 2007).
[41]. Scott, K. Handbook of Industrial Membranes 1^{st} edn, 633-639 (Elsevier, 1998).
[42]. Secor, E. B., Prabhumirashi, P. L., Puntambekar, K., Geier, M. L. & Hersam, M. C. Inkjet printing of high conductivity, flexible graphene patterns. J. Phys. Chem. Lett 4, 1347-1351 (2013).
[43]. Parate, K. et al. Aerosol-jet-printed graphene electrochemical histamine sensors for food safety monitoring. 2D Mater. 7, 034002 (2020).
[44]. Wu, J-B., Lin, M-L., Cong, X., Liu, H-N. & Tan, P-H. Raman spectroscopy of graphene-based materials and its applications in related devices. Chem. Soc. Rev. 47, 1822-1873 (2018).
[45]. ISO Standard 14040:2006 Environmental Management—Life Cycle Assessment—Principles and Framework (International Organization for Standardization, 2006).
[46]. ISO Standard 14044:2006 Environmental Management—Life Cycle Assessment—Requirements and Guidelines (International Organization for Standardization, 2006).
[47]. Zhang, J., Meerman, H., Benders, R. & Faaij, A. Techno-economic and life cycle greenhouse gas emissions assessment of liquefied natural gas supply chain in China. Energy 224, 120049 (2021).
[48]. Kuramochi, T., Ramirez, A., Turkenburg, W. & Faaij, A. Comparative assessment of CO₂ capture technologies for carbon-intensive industrial processes. Prog. Energy Combust. Sci. 38, 87-112 (2012).
[49]. Wang, X., Bai, H., & Shi, G. Size fractionation of graphene oxide sheets by pH-assisted selective sedimentation. J. Am. Chem. Soc. 133, 6338-6342 (2011).
[50]. Zhang, W. et al. Size fractionation of graphene oxide sheets by the polar solvent-selective natural deposition method. RSC Adv. 5, 146-152 (2015).
[51]. Kang, J. et al. Thickness sorting of two-dimensional transition metal dichalcogenides via copolymer-assisted density gradient ultracentrifugation. Nat. Commun. 5, 5478 (2014).
[52]. Backes, C. et al. Edge and confinement effects allow in situ measurement of size and thickness of liquid-exfoliated nanosheets. Nat. Commun. 5, 4576 (2014).
[53]. Khan, U. et al. Size selection of dispersed, exfoliated graphene flakes by controlled centrifugation. Carbon 50, 470-475 (2012).
[54]. Pachauri, R. K. M. et al. in Climate Change 2014: Synthesis Report. Contribution of Working Groups I, II, III to the Fifth Assessment Report of the Intergovernmental Panel on Climate Change. Report No. 978-92-9169-143-2 (IPCC, Geneva, Switzerland, 2015).
[55]. Nieuwlaar, E., Roes, A. L. & Patel, M. K. Final energy requirements of steam for use in environmental life cycle assessment. Journal of Industrial Ecology 20, 828-836 (2016).
[56]. State Electricity Profiles—Illinois (Energy Information Administration, 2020), https://www.eia.gov/electricity/state/.
[57]. National Occupational Employment and Wage Estimates (U. S. Bureau of Labor Statistics, 2020); https://www.bls.gov/oes/2020/may/oes_nat.htm #00-0000.
[58]. Short, W. P., Daniel J. & Holt, T., in A Manual for the Economic Evaluation ofEnergy Efficiency and Renewable Energy Technologies (National Renewable Energy Laboratory, 1995); https://doi.org/10.2172/35391.
[59]. Davis, R. E. et al. in Process Design and Economics for the Conversion of Lignocellulosic Biomass to Hydrocarbon Fuels and Coproducts: 2018 Biochemical Design Case Update; Biochemical Deconstruction and Conversion of Biomass to Fuels and Products via Integrated Biorefinery Pathways (National Renewable Energy Laboratory, 2018), https://www.nrel.gov/docs/fy19osti/71949.pdf.
[60]. Gao, S. W., Gong, X. Z., Liu, Y. & Zhang, Q. Q. Energy consumption and carbon emission analysis of natural graphite anode material for lithium batteries. Mater. Sci. Forum 913, 985-990 (2018).
[61]. Zhang, Q. Q. G., Xian Zheng; Meng, Xian Ce. Environment impact analysis of natural graphite anode material production. Mater. Sci. Forum 913, 1011-1017 (2018).
[62]. Manjong, N. B., Usai, L., Burheim, O. S. & Stromman, A. H. Life cycle modelling of extraction and processing of battery minerals—a parametric approach. Batteries 7, 1-26 (2021).
[63]. Alberola-Borras, J. A. et al. Perovskite photovoltaic modules: life cycle assessment of pre-industrial production process. iScience 9, 542-551 (2018).
[64]. GREET: The Greenhouse Gases, Regulated Emissions, and Energy Use in Technologies Model by Argonne National Laboratory (ANL, 2021); https://greet.es.anl.gov/.
[65]. Prezelus, F., Ecodesign of Ultrafiltration Membranes for Drinking Water Production: An Experimental andModelling Approach. PhD Thesis, Institut National Polytechnique de Toulouse (2019); https://oatao.univ-toulouse.fr/27754/.
[66]. Yadav, P. et al. Assessment of the environmental impact of polymeric membrane production. J. Membr. Sci. 622, 118987 (2021).
[67]. Brandt, B., Kletzer, E., Pilz, H., Hadzhiyska, D., & Seizov, P. in Silicon-Chemistry Carbon Balance: An Assessment of Greenhouse Gas Emissions and Reductions (Global Silicones Council, 2012); https://www.silicones.eu/resources/.
[68]. The Management of Ethanol Production in Illinois: White Paper (Illinois Fire Service, 2008); https://www.fsi.illinois.edu/documents/ethanol/Ethanol %20White %20Paper %203.pdf.
[69]. Factors to Consider When Replacing a Laboratory Centrifuge (NuAire, 2018); https://www.news-medical.net/whitepaper/20180731/Factors-to-Consider-When-Replacing-a-Laboratory-Centrifuge.aspx.
[70]. a) Rotor Safety Guide, https://www.chem.purdue.edu/chemsafety/docs/news-stories/RotorSafetyGuide.pdf, b) J-Lite JLA-8.1000 and JLA-9.1000 Fixed-Angle Rotor Assemblies, https://physiology.case.edu/media/eq_manuals/eq_manual_Beckman_JLA-8-1000_JLA-9-1000_Fixed_Angle_Rotor_Manual.pdf (Beckman Coulter, 2021).
[71]. Pump Life Cycle Costs: A Guide to LCC Analysis for Pumping Systems (The Hydraulic Institute, Europump, and US Department of Energy's Office of Industrial Technologies, 2001); https://wwwl. eere.energy.gov/manufacturing/tech_assistance/pdfs/pumplcc_1001.pdf.
[72]. Lukat, R., Understanding Pressure Sensor Failure and Reliability (WIKA, 2015); https://blog.wika.us/products/pressure-products/understanding-pressure-sensor-failure-reliability/.
[73]. Hei-VAP Industrial Series Large-Scale Rotary Evaporators (eHeidolph, 2013); https://beta-static.fishersci. com/content/dam/fishersci/en_US/documents/programs/scientific/brochur es-and-catalogs/catalogs/heidolph-large-scale-rotary-evaporators-catalog.pdf.
[74]. Energy Efficiency of Infrared Lamps (Phormalab, 2019); https://www.phormalab.it/en/energy-efficiency-of-infrared-lamps/.
[75]. Karagiannidis, P., et al., Layered materials and methods for their processing, U.S. Pat. No. 10,906,814 B2, (Feb. 2, 2021).
[76]. Torrisi, F., et al., Functional inks based on layered materials and printed layered materials, EP Patent No. 2909277 B1, (Sep. 4, 2019).
[77]. Marinaccio, P. J., et al., Cross-flow filtration, U.S. Pat. No. 4,888,115, (Dec. 19, 1989).
[78]. Brellisford, D., et al., Chromatography membranes, devices containing them, and methods of use thereof, U.S. Pat. No. 10,981,949 B2, (Apr. 20, 2021).
[79]. Gebauer, K., et al., Method for pressure control in crossflow filtration, PCT Application Publication No. WO2017144440A2, (Aug. 31, 2017).
[80]. Eriksson, C. O., Norrman, N., Automated multi-step purification system, U.S. Pat. No. 10,429,359 B2, (Oct. 1, 2019).
[81]. Ward, T. R., et al., Disposable Alternating Tangential Flow Filtration Units, U.S. Patent Application Publication No. US2022/0008803 A1, (Jan. 13, 2022).
[82]. Kaduchak, G., et al., Methods and systems for controlling the flow of particles for detection, U.S. Pat. No. 8,873,051 B2, (Oct. 28, 2014).
[83]. Puleo, C. M., et al., Method for separation of particulates, EP Patent No. 3083051 B1, (Jul. 28, 2021).

What is claimed is:

1. An apparatus for two-dimensional (2D) material separation and material recovery, comprising:
a first cross-flow filtration system, and a second cross-flow filtration system, wherein each of the first and second cross-flow filtration systems comprises:
a feed reservoir receiving a feed dispersion;
a feed pump fluidically coupled to the feed reservoir for delivering the feed dispersion;
a permeate pump; and
a cross-flow filter having feed, retentate, and permeate ports fluidically and respectively coupled to the feed pump, the feed reservoir and the permeate pump for cross-flow filtration of the feed dispersion into a retentate dispersion that is returned into the feed reservoir and a permeate dispersion that is collected through the permeate pump;
wherein the feed reservoir of the first cross-flow filtration system is operably fed with a mixture dispersion containing a 2D material, at least one processing solvent and at least one stabilizing polymer; and the permeate dispersion of the first cross-flow filtration system is fed to the feed reservoir of the second cross-flow filtration system; and
wherein the retentate dispersion of the second cross-flow filtration system contains a concentrated dispersion of the 2D material, and the permeate dispersion of the second cross-flow filtration system is collected for recovery of the at least one processing solvent and the at least one stabilizing polymer.

2. The apparatus of claim 1, wherein each of the first and second cross-flow filtration systems further comprises a plurality of pressure sensors for monitoring pressure at the feed, retentate, and permeate ports, respectively.

3. The apparatus of claim 1, further comprising a controller for controlling operations of the feed pumps of the first and second cross-flow filtration systems.

4. The apparatus of claim 3, wherein the controller comprises a first controller and a second controller respectively coupled to the first and second cross-flow filtration systems for the operations of the feed pumps of the first and second cross-flow filtration systems.

5. The apparatus of claim 1, wherein the cross-flow filter comprises cross-flow filtration (CFF) membranes in tubular, flat sheet, spiral-wound, and/or hollow-fiber configurations.

6. The apparatus of claim 5, wherein the CFF filter membrane is formed of a polymeric material including polysulfone (PS), polyethersulfone (PES), modified polyethersulfone (mPES), mixed cellulose ester (MCE), nylon, polyacrylonitrile (PAN), polypropylene (PP), and/or polyimide (PI).

7. The apparatus of claim 5, wherein the CFF filter membrane surface is composed of a ceramic material including silicon carbide (SiC), titania (TiO₂), zirconia (ZrO₂), yttrium-stabilized zirconia (YSZ), or alumina (Al₂O₃).

8. The apparatus of claim 5, wherein the CFF membranes are charged membranes.

9. The apparatus of claim 5, wherein the first cross-flow filtration system is a cross-flow microfiltration (CF-MF) system with the CFF membranes having microscale pores with pore sizes in a range of about 0.1-1 μm.

10. The apparatus of claim 9, wherein the pore sizes are about 0.65 μm.

11. The apparatus of claim 5, wherein the second cross-flow filtration system is a cross-flow ultrafiltration (CF-UF) system with the CFF membranes having nanoscale pores with nanoscale sizes.

12. The apparatus of claim 11, wherein the nanoscale pore sizes are in a range of 500-750 kDa NMWC.

13. The apparatus of claim 1, wherein the 2D material comprises a liquid-exfoliated 2D material from van der Waals layered solids.

14. The apparatus of claim 13, wherein the liquid-exfoliated 2D material comprises graphene, black phosphorous (BP), hexagonal boron nitride (hBN), molybdenum disulfide (MoS₂), tungsten disulfide (WS₂), germanium sulfide (GeS), tin disulfide (SnS₂), tantalum disulfide (TaS₂), rhenium disulfide (ReS2), molybdenum diselenide (MoSe₂), tin selenide (SnSe), tungsten diselenide (WSe₂), bismuth selenide (Bi₂Se₃), indium selenide (InSe), molybdenum ditelluride (MoTe₂), gallium telluride (GaTe), or any of other liquid-phase exfoliated materials derived from layered oxides, layered hydroxides, and layered silicates.

15. The apparatus of claim 14, wherein the at least one processing solvent comprises ethanol, and the at least one stabilizing polymer comprises ethyl cellulose (EC), hydroxypropyl methylcellulose (HPMC), nanocrystalline cellulose (CNC); other naturally occurring biopolymers including chitosan, collagen, or starch; a synthesized macromolecule including polyvinylpyrrolidine (PVP), polyethylene oxide (PEO), or block copolymers such as poloxamers; small aromatic molecules including pyrene derivatives; or small-molecule surfactants including sodium cholate (SC), sodium dodecyl sulfate (SDS), or sodium deoxycholate (SDC).

16. The apparatus of claim 15, wherein the CF-MF permeate is fed in the feed port of the CF-UF as the feed dispersion for the CF-UF, with ethanol and EC then traversing the CF-UF membrane into the CF-UF permeate.

17. The apparatus of claim 16, wherein the CF-UF retentate of the CF-UF comprises electronic-grade 2D nanoparticles usable for formulating a printable ink.

18. A method for two-dimensional (2D) material separation and material recovery, comprising:
providing a mixture dispersion containing 2D material, at least one processing solvent and at least one stabilizing polymer;
cross-flow filtering the mixture dispersion into a permeate dispersion; and
cross-flow filtering the permeate dispersion into a fine retentate dispersion and a fine permeate dispersion, wherein the fine retentate dispersion comprises the 2D material and the fine permeate dispersion comprises the at least one processing solvent and the at least one stabilizing polymer.

19. The method of claim 18, wherein each of said cross-flow filtering the mixture dispersion and said cross-flow filtering the permeate dispersion is performed with a cross-flow filtration system having a cross-flow filter comprising cross-flow filtration (CFF) membranes in tubular, flat sheet, spiral-wound, and/or hollow-fiber configurations.

20. The method of claim 19, wherein said cross-flow filtering the mixture dispersion is performed with a cross-flow microfiltration (CF-MF) system with the CFF membranes having microscale pores with pore sizes in a range of about 0.1-1 μm.

21. The method of claim 20, wherein the pore sizes are about 0.65 μm.

22. The method of claim 20, wherein said cross-flow filtering the permeate dispersion is performed with a cross-flow ultrafiltration (CF-UF) system with the CFF membranes having nanoscale pores with nanoscale sizes.

23. The method of claim 22, wherein the nanoscale pore sizes are in a range of 500-750 kDa NMWC.

24. The method of claim 22, wherein each of said cross-flow filtering the mixture dispersion and said cross-flow filtering the permeate dispersion comprises:
slowly increasing a feed flow rate to about 50-100% of the maximum afforded by a feed pump; and
gradually increasing a permeate flow rate towards a predetermined target parameter based on the membrane surface area until the transmembrane pressure (TMP) is maximized and stable.

25. The method of claim 24, wherein said cross-flow filtering the permeate dispersion is conducted in a concentration mode to facilitate ethanol recovery.

26. The method of claim 25, wherein the permeate flow rate of said cross-flow filtering the permeate dispersion is higher than that of said cross-flow filtering the mixture dispersion.

27. The method of claim 18, wherein the mixture dispersion is provided by liquid-phase exfoliation (LPE) of van der Waals layered solids in the presence of the at least one stabilizing polymer.

28. The method of claim 27, wherein the 2D material comprises a liquid-exfoliated 2D material from van der Waals layered solids.

29. The method of claim 28, wherein the liquid-exfoliated 2D material comprises graphene, black phosphorous (BP), hexagonal boron nitride (hBN), molybdenum disulfide (MoS₂), tungsten disulfide (WS₂), germanium sulfide (GeS), tin disulfide (SnS₂), tantalum disulfide (TaS₂), rhenium disulfide (ReS₂), molybdenum diselenide (MoSe₂), tin selenide (SnSe), tungsten diselenide (WSe₂), bismuth selenide (Bi₂Se₃), indium selenide (InSe), molybdenum ditelluride (MoTe₂), gallium telluride (GaTe), or any of other liquid-phase exfoliated materials derived from layered oxides, layered hydroxides, and layered silicates.

30. The method of claim 29, wherein the at least one processing solvent comprises ethanol, and the at least one stabilizing polymer comprises ethyl cellulose (EC), hydroxypropyl methylcellulose (HPMC), nanocrystalline cellulose (CNC); other naturally occurring biopolymers including chitosan, collagen, or starch; a synthesized macromolecule including polyvinylpyrrolidine (PVP), polyethylene oxide (PEO), or block copolymers such as poloxamers; small aromatic molecules including pyrene derivatives; or small-molecule surfactants including sodium cholate (SC), sodium dodecyl sulfate (SDS), or sodium deoxycholate (SDC).

31. The method of claim 18, wherein the method reduces greenhouse gas emissions, fossil energy usage, water consumption, and specific production costs of 2D material manufacturing by about 57%, 56%, 63%, and 52%, respectively, compared to conventional centrifuge-based separation (CBS) processing.

32. The method of claim 18, wherein the fine retentate dispersion comprises electronic-grade 2D nanoparticles usable for formulating a printable ink.

33. A printable ink, comprising the 2D material separated by the method of claim 18.
